(19) United States
(12) Patent Application Publication
(10) Pub. No.: US 2003/0214478 A1
(43) Pub. Date: Nov. 20, 2003

(54) Backlight assembly having external electrode fluorescent lamp, method of driving thereof and liquid crystal display having the same

(76) Inventors: Hyeong-Suk Yoo, Seongnam-si (KR); Sung-Chul Kang, Yongin-si (KR); Jeong-Hwan Lee, Suwon-si (KR); Keun-Woo Lee, Hwaseong-gun (KR); Moon-Sik Kang, Seongnam-Si (KR)

Correspondence Address: CANTOR COLBURN LLP, 55 Griffin Road South, Bloomfield, CT, 06002, US

(21) Appl. No.: 10/401,314

(22) Filed: Mar. 26, 2003

(30) Foreign Application Priority Data
May 17, 2002 (KR) 2002-27461

(51) Int. Cl. G09G 3/36

(52) U.S. Cl. 345/102

(57) ABSTRACT

A backlight assembly has a lamp driving device for driving external electrode fluorescent lamps (EEFLs) parallel connected each other. The lamp driving device includes a power switch transistor, a diode, an inverter and a PWM controller. The transistor converts external DC power signal into pulse power signal based on switching signal, the diode prevents rush current from flowing into the transistor. The inverter converts the pulse power signal into AC power signal, raises voltage level of the AC power signal, and provides the lamps with the raised AC power signal. The PWM controller is activated by external on/off signal to provide the transistor with the switching signal so as to regulate voltage level of the AC power signal. The EEFLs can maintain a constant current level, and the backlight assembly can have characteristics of uniform luminance, high luminance and high heat efficiency.

### CROSS-REFERENCE OF RELATED APPLICATIONS

This application relies for priority upon Korean Patent Application No. 2002- 27461 filed on May 17, 2002, the contents of which are herein incorporated by reference in its entirety.

### BACKGROUND OF THE INVENTION

1. Field of the Invention

The present invention relates to a backlight assembly having external electrode fluorescent lamps, a driving method thereof and an LCD apparatus having the same.

2. Description of the Related Art

In general, flat panel display devices are divided into an emissive display device and a non-emissive display device. The emissive display device includes a cathode ray tube (CRT), a plasma display panel (PDP), an electroluminescent display device (ELD), a vacuum fluorescent display device (VFD) and a light emitting diode (LED) etc. The non-emissive display device includes a liquid crystal display (LCD) device.

The LCD device is a passive plat panel display device in which an image is displayed using the light from external light source. A backlight assembly is disposed under a LCD panel so as to provide the LCD panel with lights. The backlight assembly requires high luminance, high light efficiency, uniformity of luminance, long endurance, thin thickness, lightweight, and a low price.

A laptop computer such as a notebook computer, requires a lamp having high efficiency and long endurance, and a monitor for a desktop computer and a television set requires to have high luminance.

On the other hand, the backlight assemblies are generally divided into a cold cathode fluorescent lamp (CCFL) type backlight assembly and a flat fluorescent lamp type backlight assembly. In the flat fluorescent lamp type backlight assembly, upper and lower substrates are coated with a fluorescent material so as to output lights. The CCFL type backlight assembly is divided into an edge-illuminating type backlight assembly and a direct illuminating type backlight assembly depending on the light sources arranged with respect to the display screen. The edge-illuminating type backlight assembly uses a light guiding plate. Light sources are arranged at side portions of the light guiding plate. In the direct illuminating type backlight assembly, the light sources are arranged under the LCD panel.

FIG. 1 is an exploded perspective view showing a conventional LCD device, especially an edge-illuminating type LCD device. FIGS. 2, 3 and 4 are circuit diagrams showing examples of inverters for driving a lamp of a backlight assembly of FIG. 1.

Referring to FIG. 1, the LCD device 900 includes an LCD module 700 for receiving image signals to display an image, a front case and a rear case. The front and the rear case receive the LCD module 700. The LCD module 700 includes a display unit 710. The display unit 710 includes an LCD panel 712 for displaying an image.

The display unit 710 includes the LCD panel 712, a data side printed circuit board (PCB; 714), a gate side PCB 719, a data side tape carrier package (TCP; 716) and a gate side TCP 716.

The LCD panel includes a thin film transistor (TFT) substrate 712a, a color filter substrate 712b and liquid crystal (not shown), and displays an image.

Particularly, the TFT substrate 712a is a transparent substrate on which TFTs are arranged in a matrix shape. A data line is connected to a source of each of TFTs, and a gate line is connected to a gate of each of TFTs. Also, a pixel electrode is formed on each of drains of the TFTs, the pixel electrode comprises a transparent conductive material, such as indium tin oxide (ITO).

When electric signals are applied to data lines and gate lines, the electric signals are inputted into the sources and gates of the TFTs, the TFTs are turned on or turned off depending on the electric signals, and the drain of each of TFTs outputs an electric control signal to display a pixel image.

The color filter substrate 712b is opposite to the TFT substrate 712a. A plurality of RGB color pixels is formed through a thin film fabricating process. Lights pass through the color pixels to display predetermined colors. A common electrode that comprises ITO is formed on a front surface of the color filter substrate 712b.

When an electric power signal is applied to the gates and sources of the TFTs, the TFTs are turned on, and an electric field are formed between the pixel electrode and the common electrode of the color filter substrate. The electric field varies an arranging angle of liquid crystal molecules that are interposed between the TFT substrate 712a and the color filter substrate 714b, and a light transmissivity of the liquid crystal is varied depending on the varied tilt angle of the liquid crystal to display desired pixel image.

A driving signal and timing control signal are applied to the gate lines and data lines of the TFTs so as to control the arranging angle of the liquid crystal and to control timing of tilting the liquid crystal. The data side TCP 716 is attached to a side of the LCD panel 712 near the sources of the TFTs, and the gate side TCP 718 is attached to another side of the LCD panel 712 near the gates of the TFTs. The data side TCP 716 is a kind of flexible printed circuit board that determines when to apply a driving signal for driving the data line, and the gate side TCP 718 is also a kind of flexible printed circuit board that determines when to apply a driving signal for driving the gate line.

A data side PCB 714, which receives external image signals and applies a data driving signals to the data lines, and a gate side PCB 719, which applies a gate driving signals to the gate lines, are coupled to both the data side TCP 716 near the data lines of the LCD panel 712 and the gate side TCP 718 near the gate lines of the LCD panel 718, respectively.

A source part is formed in the data side PCB 714, and the source part receives image signals generated from an external data processing device (not shown) to provide the LCD panel 712a with data driving signal for driving the data lines. A gate part is formed in the in the gate side PCB 714, and the gate part provides the LCD panel 712a with gate driving signal for driving the gate lines.

The data side PCB 714 and the gate side PCB 719 generate the gate driving signal, the data driving signal and a plurality of timing control signals for applying these driving signals at an appropriate time. The gate driving signal is applied to the gate line of the LCD panel 712 through the gate side TCP 718, and the data driving signal is applied to the data line of the LCD panel 712 through the data side TCP 718.

A backlight assembly 720 is disposed under the display unit 710. The backlight assembly 720 provides the display unit 710 with uniform light. The backlight assembly 720 includes a first lamp part 723 and a second lamp part 725. The first lamp part 723 and the second lamp part 725 is disposed at both ends of the LCD module 700 and generate lights. The first lamp part 723 includes a first lamp 723a and a second lamp 723b that are protected by a first lamp cover 722a. The second lamp part 725 includes a third lamp 725a and a fourth lamp 725b that are protected by a second lamp cover 722b.

A light guiding plate 724 has a size corresponding to that of the LCD panel 712 of the display unit 710. The light guiding plate 724 is disposed under the LCD panel 712, and guides the lights generated from the first and second lamp parts 723 and 725 toward the display unit 710 to change a path of the lights.

The light guiding plate is an edge illuminating type and has a uniform thickness, the first and second lamp parts 723 and 725 are disposed at both ends of the light guiding plate 724. The first and second lamp parts 723 and 725 have an appropriate number of lamps in view of an overall valance of the LCD device 900 when the lamps are arranged in the LCD device 900.

A plurality of optical sheets is disposed over the light guiding plate 724. The optical sheets allow the lights that are emitted from the light guiding plate 724 to advance toward the LCD panel 712, to have a uniform brightness. A reflection plate 724 is disposed under the light guiding plate 724, and enhances light efficiency by reflecting the lights leaked from the light guiding plate 724 back toward the light guiding plate.

A mold frame 730, i.e. a receiving container, supports and secures the display units 710 and the backlight assembly 720. The mold frame 730 has a cubic shape. An upper portion of the mold frame 730 is opened.

The data side PCB 714 and the gate side PCB 719 are bent toward an external direction of the mold frame 730. The chassis 740 secures the data side and gate side PCBs 714 and 719 to the lower surface of the mold frame 730, to thereby prevent the separation of the display unit 710 from the mold frame 730. The chassis 740 is opened so as to expose the LCD panel 710. Side surfaces of the chassis 740 are bent vertically toward inside the LCD device, and cover portions around an upper surface of the LCD panel 710.

The LCD device 900, although not shown in FIG. 1, includes a first inverter (INV1) so as to drive the first, second, third and fourth lamps 723a, 723b, 725a and 725b, as shown in FIG. 2.

Referring to FIG. 2, the first inverter INV1 includes a first transformer T1 and a second transformer T2, a first regulator 723e and a second regulator 725e. An output terminal of a secondary coil of the first transformer T1 has a high voltage level, and is connected to input terminal, i.e. first electrodes, of the first and second lamps 723a and 723b, respectively, through first and second ballast capacitors C1 and C2.

Each of the output terminals, i.e. a second electrode, of. the first and second lamps 723a and 723b is connected to the first regulator 723e inside the first inverter INV1 through first and second return wires (hereinafter referred to as RTN) 723c and 723d, respectively.

The first and second RTNs 723c and 723d are connected to the first regulator 723e, and output a feedback current. Referring to FIG. 2 again, each of the first electrodes of the third and fourth lamps 725a and 725b is connected to the output terminal, which has a high voltage level, of the secondary coil of the second transformer T2 through third and fourth ballast capacitors C3 and C4.

Each of the second electrodes of the third and fourth lamps 725a and 725b is connected to the second regulator 725e inside the first inverter INV1 through third and fourth RTNs 725c and 725d, respectively, to thereby to output feedback current.

However, when one transformer drives a plurality of lamps and each of the lamps is connected in parallel, a lamp current provided from one transformer is divided and applied to each of the lamps.

Accordingly, each of the currents applied to each of the lamps has a current difference due to a variable resistance and leakage current difference of each of the lamps. These current difference increases according as the lamp current provided from the transformer decreases, so that each of the lamps has different endurance because some lamps do not operate when total lamp current is small.

TABLE 1

| | Current | Current | | |
|---|---|---|---|---|
| Total | (723a) | (723b) | | |
| lamp | applied to | applied to | Current | Average |
| current | lamp 1 | lamp 2 | difference | current |
| 12.7 | 6.9 | 5.8 | 1.1 | 6.35 |
| 11.2 | 6.6 | 4.6 | 2.0 | 5.60 |
| 9.7 | 7.5 | 2.2 | 5.3 | 4.85 |
| 8.0 | 7.0 | 1.0 | 6.0 | 4.00 |
| 5.8 | 5.8 | 0 | 5.8 | 2.90 |
| 4.0 | 4.0 | 0 | 4.0 | 2.00 |

To solve above problems, one transformer has been connected to one lamp in one-and-one to drive the lamps, as shown in FIG. 3.

Referring to FIG. 3, a second inverter IN2 includes first, second, third and fourth transformers T1, T2, T3 and T4, a first regulator 723e and a second regulator 725e. First, second, third and fourth controllers CT1, CT2, CT3 and CT4 drive the first, second, third and fourth transformers T1, T2, T3 and T4, respectively. Each of the first electrodes of the first and second lamps 723a and 723b is connected to the output terminal, which has the high voltage level, of the secondary coil of the first and second transformers T1 and T2 through the first and second ballast capacitors C1 and C2, respectively. Each of the second electrodes of the first and second lamps 723a and 723b is connected in series to the first regulator 723e inside the second inverter INV2 through the first and second RTNs 723c and 723d, respectively. Also, each of the first electrodes of the third and fourth lamps 725a and 725b is connected to the output terminal, which has the high voltage level, of the secondary coil of the third and fourth transformers T3 and T4 through the third and fourth ballast capacitors C3 and C4, respectively. Each of the second electrodes of the third and fourth lamps 725a and 725b is connected in series to the second regulator 725e inside the second inverter INV2 through the third and fourth RTNs 725c and 725d, respectively.

However, when one transformer is connected to one lamp in one-and-one so as to drive the lamps, as shown in FIG. 3, it is difficult to synchronize the frequency between each of the transformers. Accordingly, a flickering phenomenon that cause the lights generated from the lamp to be flickered, occurs so that an appropriate light source as a backlight of the LCD device cannot be provided.

To solve above problems, as shown in FIG. 4, one transformer has been connected to one lamp in one-and-one, and pair of transformers has been coupled to each other.

Referring to FIG. 4, a third inverter INV3 includes first, second, third and fourth transformers T1, T2, T3 and T4, a first regulator 723e and a second regulator 725e. A low voltage level terminals of the primary coil of the first and second transformers T1 and T2 are directly coupled with each other, and a low voltage level terminals of the primary coil of the third and fourth transformers T3 and T4 are directly coupled with each other. A first controller CT1 drives the first and second transformers T1 and T2. A second controller CT2 drives the third and fourth transformers T3 and T4.

A first electrode of the first lamp 723a is connected to the output terminal, which has the high voltage level, of the secondary coil of the first transformer T1 through the first ballast capacitor C1. A first electrode of the second lamp 723b is connected to the output terminal, which has the high voltage level, of the secondary coil of the second transformer T2 through the second ballast capacitor C2. Each of the second electrodes of the first and second lamps 723a and 723b is connected in series to the first regulator 723e inside the third inverter INV3 through the first and second RTNs 723c and 723d, respectively. Also, each of the first electrodes of the third lamp 725a is connected to the output terminal, which has the high voltage level, of the secondary coil of the third transformer T3 through the fourth ballast capacitor C4, respectively. Each of the second electrodes of the third and fourth lamps 725a and 725b is connected in series to the second regulator 725e inside the third inverter INV3 through the third and fourth RTNs 725c and 725d, respectively.

However, although coupling a pair of transformer with each other may prevent the generations of the frequency synchronization and flickering phenomenon, the second electrode of each of the lamps is electrically connected to the regulator through the RTN extended toward the inverter. Accordingly, wiring may be difficult, and further the cost of manufacturing the backlight assembly according may increase as the number of the lamps increases.

FIGS. 5A and 5B are a schematic view showing lamps and inverters of a conventional direct illuminating type LCD device, respectively.

Referring to FIG. 5A, according to the conventional direct illuminating type LCD device, lamps 727 that provide light source are arranged on a reflection plate 728 interposed between the lamps 727 and the bottom surface of the mold frame 730. Also, since the lamps 727 provides light sources under the bottom surface of the display unit 710, a light guiding plate 724 of FIG. 1 that guides side light sources to the display unit 710.

The direct illuminating type LCD device 900, as shown in FIG. 5B, may use a plurality of lamps 727a, 727b, 727c, 727d, 727e, 727f, 727g and 727h. A structure of the second inverter INV2 or the third inverter INV3, which is shown in FIGS. 3 and 4, is employed to the structure of the fourth inverter INV4. In other words, the engaging structure of the plurality of lamps 727a, 727b, 727c, 727d, 727e, 727f, 727g and 727h is the same as in the engaging structure between the second and third inverters INV2 and INV3. Also, each of the second electrodes of the plurality of lamps 727a, 727b, 727c, 727d, 727e, 727f, 727g and 727h is connected to a regulator (not shown) inside the fourth inverter INV4 through each of the RTNs RTN1, RTN2, RTN3, RTN4, RTN5, RTN6, RTN7 and RTN8.

As described above, according to the conventional backlight assembly of the LCD device employs the CCFL, the CCFL transforms from a low voltage signal having a frequency of tens of kHz generated from an LC resonance type inverter by means of a step-up transformer into a high voltage signal enough to start the discharging of the CCFL. In this case, the output signal of the inverter has a sinusoidal wave. The LC resonance type inverter has a simple structure and has a high efficiency. However, a plurality of CCFLs connected in parallel to each other cannot be driven with only one LC resonance inverter. Therefore, the direct illuminating type backlight assembly or the backlight assembly having CCFLs combined with a light guiding plate needs inverters having the same number as that of the CCFLs.

The usual CCFL operates in a condition of a luminance of 30,000 cd/m², and has a short endurance. Especially, the CCFL employed in the edge illuminating type backlight assembly emits a high luminance of lights, but the LCD panel has a low luminance, so that the edge illuminating type backlight assembly having CCFLs are not appropriate for an LCD panel having a large display screen.

Also, in the direct illuminating type backlight assembly, a plurality of CCFLs is connected in parallel, and the plurality of CCFLs cannot be driven with only one inverter. In the direct illuminating type backlight assembly, the number of the CCFLs is limited, and the intervals between each of the CCFLs are large, so that a light guiding plate having a special structure is needed. Also, in the direct illuminating type backlight assembly, the distance between a diffusion plate and the lamp increases, so that the thickness of the LCD panel increases.

In a flat fluorescent lamp type backlight assembly, the LCD panel preferably has a thickness enough to prevent the glass substrates from being broken down since the internal pressure between the upper and lower substrate is lower than atmospheric pressure, so that the LCD panel becomes heavy. Also, in the flat fluorescent lamp type backlight assembly, bead-shaped spacers or cross-shaped partition walls are interposed between the upper substrate and the lower substrate. Thus, the flat fluorescent lamp type backlight assembly may be heavy due to the thick thickness of the LCD panel and heat may be wasted due to a low heat efficiency. Especially, when the partition walls are employed, the stripe patterns of the partition walls are shown in the display screen, the luminance may not be uniform.

In an LCD device having a large-scale screen, there has been required a backlight assembly that can guarantee a high luminance and a high heat efficiency and simultaneously has a long endurance and lightweight, so that an EEFL (External Electrode fluorescent Lamp) has been developed. An external electrode is formed on a glass tube in the EEFL.

FIGS. 6A, 6B, 6C and 6D are schematic views showing a conventional external electrode fluorescent lamp.

In a belt type EEFL 10 shown in FIG. 6A, pairs of belt electrodes are formed on an outer surface 12 of the glass tube of the belt type EEFL 10, a short belt electrode is used, and the belt type EEFL 10 is driven by a high frequency signal having more than a few times of MHz. Since the electrodes are formed on the outer surface 12 of the glass tube in the belt type EEFL 10, the belt type EEFL 10 is advantageous in that electrodes 16 and 16′ can be formed on a middle outer surface of the glass tube.

Recently, a direct illuminating type backlight assembly having the belt type EEFLs disposed over a reflection plate has been suggested. The belt type EEFL 10 has been driven by a high frequency signal having a few MHz to provide a high luminance having a few times of 10,000 cd/m². Especially, belt type electrodes 16 and 16′ can be formed on a middle outer surface of the glass tube driven by a high frequency when a long glass tube is used.

In a metal capsule type EEFL 20 shown in FIG. 6B, metal capsules are formed on both ends of the glass tube 22, ferroelectrics material is coated inside the metal capsule. The above structure is disclosed in U.S. Pat. No. 2,624,858 (issued on Jun. 6, 1953). The metal capsule type EEFL 20 is employed when the glass tube has a large radius.

In addition, as shown in FIGS. 6C and 6D, a second type of EEFL is disclosed in the U.S. Pat. No. 2,624,858 (issued on Nov. 28, 1926). In the second type of EEFL, both ends of the glass tube have a larger space than the middle portion of the glass tube.

In the edge-illuminating or direct illuminating type backlight assembly, a plurality of EEFLs is connected in parallel, and the EEFLs can be driven with one inverter. Since the electrode is not exposed to a discharging space in the EEFL, current does not flow into the electrode, wall current is collected at both electrode, a reverse electric field is formed between both ends of the lamp tube, and the discharging process stops. Then, since another lamp begins to discharge, the wall current is formed, and a next lamp begins to discharge sequentially, so that only one inverter can drive a plurality of lamps.

However, an EMI (electromagnetic Interference) trouble due to the high frequency, a low heat efficiency and a problem due to a high frequency power supply occur since the above mentioned EEFLs are driven by a high frequency signal of a few times MHz so as to provide a high luminance, those EEFLs may not employed as a light source in the backlight assembly.

In other words, when the EEFL is driven by the inverter producing sinusoidal wave so as to drive the CCFL, since the wall current cannot be controlled effectively, the EEFL has a very lower luminance and very lower heat efficiency compared with an EEFL with a glass tube.

Also, when the LC resonance inverter driving the CCFL is employed in the EEFL, the EEFL may not be employed as a light source of the backlight assembly because of a very low and very low heat efficiency.

### BRIEF SUMMARY OF THE INVENTION

Accordingly, the present invention is provided to substantially obviate one or more problems due to limitations and disadvantages of the related art.

It is a first feature of the present invention to provide a backlight assembly having external electrode fluorescent lamps (EEFLs) that can be driven in a constant current level when a plurality of EEFLs, in which an external electrode is formed at both ends of the lamp tube, and a plurality of EIFLs (External Inner electrode fluorescent Lamps), in which an external electrode is formed at one end of the glass tube and an inner electrode is formed at the other end of the glass tube, are connected in parallel and are driven by a floating type fluorescent lamp driving method.

It is a second feature of the invention to provide a backlight assembly having external electrode fluorescent lamps (EEFLs) that can be driven in a constant current level by using a feedback signal from an inverter when the plurality of EEFL and the plurality of EIFL are connected in parallel and are driven by a floating type fluorescent lamp driving method.

It is a third feature of the invention to provide an a backlight assembly having external electrode fluorescent lamps (EEFLs) that can be driven in a constant current level when the plurality of EEFL and the plurality of EIFL are connected in parallel and are driven by a ground type fluorescent lamp driving method.

It is a fourth feature of the invention to provide an EEFL driving method of driving external electrode fluorescent lamps (EEFLs) according to the first feature of the invention.

It is a fifth feature of the invention to provide an EEFL driving method of driving external electrode fluorescent lamps (EEFLs) according to the second feature of the invention.

It is a sixth feature of the invention to provide an EEFL driving method of driving external electrode fluorescent lamps (EEFLs) according to the third feature of the invention.

It is a seventh feature of the invention to provide an LCD apparatus having a backlight assembly according to the first feature of the invention.

It is an eighth feature of the invention to provide an LCD apparatus having a backlight assembly according to the second feature of the invention.

It is a ninth feature of the invention to provide an LCD apparatus having a backlight assembly according to the third feature of the invention.

According to an aspect of the present invention for achieving the first feature of the present invention, there is provided a backlight assembly having an external electrode fluorescent lamp, and the backlight assembly includes a lamp driving means, a light emitting means and an optical distribution changing means. According to the first feature of the present invention, the lamp driving means receives an external DC power signal and an external dimming signal, converts the external DC power signal into an AC power signal, controls a voltage level of the AC power signal using the external dimming signal, and raises a voltage level of the AC power signal having the controlled voltage level to produce a raised AC power signal. The light emitting means has a lamp unit and generates a light based on the raised AC power signal. The lamp unit includes a plurality of parallel-connected external electrode fluorescent lamps, and at least one end of each of the external electrode fluorescent lamps has an external electrode. The optical distribution changing means changes an optical distribution of the light generated from the light emitting means.

According to another aspect of the present invention for achieving the second feature of the present invention, the light emitting means has a lamp unit for generating a light, the lamp unit includes a plurality of parallel-connected external electrode fluorescent lamps, and an external electrode is disposed at least one end of each of the external electrode fluorescent lamps. The lamp driving means receives an external DC power signal and an external dimming signal, converts the external DC power signal into an AC power signal, detects a level of a current supplied to the lamp unit, controls a level of a voltage of the AC power signal supplied to the lamp unit based on the external dimming signal and the detected current level, and raises a voltage level of the AC power signal having the controlled voltage level to provide the lamp unit with the raised AC power signal so as to control the lamp unit to generate the light using the raised AC power signal. The optical distribution changing means changes an optical distribution of the light generated from the light emitting means.

According to an aspect of the present invention for achieving the third feature of the present invention, the light emitting means has a lamp unit for generating a light. The lamp unit includes a plurality of parallel-connected external electrode fluorescent lamps. An external electrode is disposed at least one end of each of the external electrode fluorescent lamps. A first end of the lamp unit is connected to a ground. The lamp driving means receives an external DC power signal, converts the external DC power signal into an AC power signal, detects a level of a current supplied to the lamp unit, controls a level of a voltage of the AC power signal supplied to the lamp unit based on the detected current level, and raises a voltage level of the AC power signal having the controlled voltage level to provide the lamp unit with the raised AC power signal so as to control the lamp unit to generate the light using the raised AC power signal. The optical distribution changing means changes an optical distribution of the light generated from the light emitting means.

According to an aspect of the present invention for achieving the fourth feature of the present invention, there is provided a method of driving an external electrode fluorescent lamp in a lamp unit. The lamp unit includes a plurality of parallel- connected external electrode fluorescent lamps, and an external electrode is disposed at least one end of each of the external electrode fluorescent lamps. After converting an external dimming signal into an analogue dimming signal, a switching signal is generated based on an external on-off control signal and the analogue dimming signal. An external DC power signal is received, and the DC power signal is converted into a pulse power signal based on the switching signal. After converting the pulse power signal into an AC power signal, a voltage level of the AC power signal is raised to produce a raised AC power signal and then the lamp unit is provided with the raised AC power signal.

According to an aspect of the present invention for achieving the fifth feature of the present invention, after converting an external dimming signal into an analogue dimming signal, a first switching signal is generated based on an external on-off control signal and the analogue dimming signal. An external DC power signal is received, and the received DC power signal is converted into a pulse power signal based on the first switching signal. After converting the pulse power signal into an AC power signal, a voltage level of the AC power signal is raised to produce a raised AC power signal, and then a first end of the lamp unit is provided with a first raised AC power signal of the raised AC power signal. A second end of the lamp unit is provided with a second raised AC power signal of the raised AC power signal, and the second raised AC power signal has a phase difference of about 180° with respect to the first raised AC power signal. After detecting a current level of a current supplied to the lamp unit, a current level signal is produced. A second switching signal is generated based on the current level signal, the on-off control signal and the first switching signal, and then returning back to the step in which the external DC power signal is received and the DC power signal is converted into the pulse power signal based on the first switching signal.

According to an aspect of the present invention for achieving the sixth feature of the present invention, there is provided a method of driving an external electrode fluorescent lamp in a lamp unit. The lamp unit includes a plurality of parallel- connected external electrode fluorescent lamps, an external electrode is disposed at least one end of each of the external electrode fluorescent lamps, and a first end of the lamp unit is connected to a ground. After converting an external dimming signal into an analogue dimming signal, a first switching signal is generated based on an external on-off control signal and the analogue dimming signal. An external DC power signal is received, and the DC power signal is converted into a pulse power signal based on the first switching signal. After converting the pulse power signal into an AC power signal, a voltage level of the AC power signal is raised, and a raised AC power signal is produced. A second end of the lamp unit is provided with the raised AC power signal. After detecting a current level of a current supplied to the lamp unit, a current level signal is produced. A second switching signal is generated based on the current level signal, the on-off control signal and the first switching signal, and then returning back to the step in which the external DC power signal is received and the DC power signal is converted into the pulse power signal based on the first switching signal.

According to an aspect of the present invention for achieving the seventh feature of the present invention, there is provided a liquid crystal display apparatus including a backlight assembly and a display unit. The backlight assembly includes a lamp driving means, a light emitting means and an optical distribution changing means. The lamp driving means receives an external DC power signal and an external dimming signal, converts the external DC power signal into an AC power signal, controls a voltage level of the AC power signal using the external dimming signal, and raises a voltage level of the AC power signal having the controlled voltage level to produce a raised AC power signal. The light emitting means has a lamp unit and generates a light based on the raised AC power signal, the lamp unit includes a plurality of parallel-connected external electrode fluorescent lamps, and at least one end of each of the external electrode fluorescent lamps has an external electrode. The optical distribution changing means changes an optical distribution of the light generated from the light emitting means. The display unit is disposed on the optical distribution changing means and displays an image by receiving the light from the light emitting means.

According to an aspect of the present invention for achieving the eighth feature of the present invention, a light emitting means has a lamp unit for generating a light, the lamp unit includes a plurality of parallel-connected external electrode fluorescent lamps, and an external electrode is disposed at least one end of each of the external electrode fluorescent lamps. A lamp driving means receives an external DC power signal and an external dimming signal, converts the external DC power signal into an AC power signal, detects a level of a current supplied to the lamp unit, controls a level of a voltage of the AC power signal supplied to the lamp unit based on the external dimming signal and the detected current level, and raises a voltage level of the AC power signal having the controlled voltage level to provide the lamp unit with the raised AC power signal so as to control the lamp unit to generate the light using the raised AC power signal. An optical distribution changing means changes an optical distribution of the light generated from the light emitting means. A display unit is disposed on the optical distribution changing means and displays an image by receiving the light from the light emitting means.

According to an aspect of the present invention for achieving the ninth feature of the present invention, a light emitting means has a lamp unit for generating a light, the lamp unit includes a plurality of parallel-connected external electrode fluorescent lamps, an external electrode is disposed at no less than one end of each of the external electrode fluorescent lamps, and a first end of the lamp unit is connected to a ground. A lamp driving means receives an external DC power signal, converts the external DC power signal into an AC power signal, detects a level of a current supplied to the lamp unit, controls a level of a voltage of the AC power signal supplied to the lamp unit based on the detected current level, and raises a voltage level of the AC power signal having the controlled voltage level to provide the lamp unit with the raised AC power signal so as to control the lamp unit to generate the light using the raised AC power signal. An optical distribution changing means changes an optical distribution of the light generated from the light emitting means. A display unit is disposed on the optical distribution changing means and displays an image by receiving the light from the light emitting means.

According to the backlight assembly having external electrode fluorescent lamps, a driving method thereof and an LCD apparatus having the same, a plurality of EEFLs, in which an external electrode(s) is (are) formed at one or both ends of the glass tube, are connected in parallel, a constant voltage is provided to the EEFLs, so that the EEFLs can maintain a constant current level and the backlight assembly has a uniform luminance, and simultaneously a high luminance and a high heat efficiency can be obtained.

According to the present invention, when a plurality of EEFLs, which have external electrode fluorescent lamps at both ends of the lamps or EIFLs, which have external electrode fluorescent lamps at one ends of each of the lamps, connected in parallel are driven by the floating or ground type lamp driving method, the luminance level of the lamps can be controlled by providing an AC power signal of a constant voltage level to the lamps in response to an external dimming signal. Also, even though one lamp of the plurality of lamps is broken and cannot operate normally, the other lamps are not affected by the broken lamp and the voltage level between both ends of the lamps is constantly maintained.

In addition, according to the present invention, when a plurality of EEFLs connected in parallel are driven by the floating type lamp driving method, the lamp current of the lamp is indirectly detected by means of the primary coil of a transformer, and the voltage level between both ends of the lamps can be constantly maintained by controlling an external DC power signal in response to an detected lamp current. Also, the lamp current of the lamp is directly detected by means of the secondary coil of the transformer, the voltage level between both ends of the lamps can be constantly maintained by controlling an external DC power signal in response to the detected lamp current.

In addition, according to the present invention, when a plurality of EEFLs connected in parallel are driven by the ground type lamp driving method, the luminance level of the lamps can be controlled and the voltage level between both ends of the lamps can be constantly maintained by controlling an DC power signal in. response to an external dimming signal. The lamp current of the lamp is indirectly detected by means of the primary coil of a transformer in an inverter, and the voltage level between both ends of the lamps can be constantly maintained by controlling an external DC power signal in response to a detected lamp current.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing a conventional LCD device;

FIGS. 2, 3 and 4 are circuit diagrams showing examples of inverters for driving a lamp of a backlight assembly of FIG. 1;

FIGS. 5A and 5B are a schematic view showing lamps and inverters of a conventional direct illuminating type LCD device, respectively;

FIGS. 6A, 6B, 6C and 6D are schematic views showing conventional external electrode fluorescent lamps;

FIG. 7A is a schematic view showing a ground type fluorescent lamp;

FIG. 7B is a graph showing a potential difference between both ends of the EEFL in the ground type fluorescent lamp;

FIG. 8A is a schematic view showing a floating type fluorescent lamp;

FIG. 8B is a graph showing a potential difference between both ends of the EEFL in the floating type fluorescent lamp;

FIG. 9 is a circuit diagram showing a lamp driving device of a backlight assembly according to a first exemplary embodiment of the present invention;

FIGS. 10A and 10B is a graph showing difference in luminance and light efficiency characteristics between a backlight assembly having EEELs and a backlight assembly having a CCFL;

FIG. 11 is a circuit diagram showing a lamp driving device of a backlight assembly according to a second exemplary embodiment of the present invention;

FIG. 12 is a flowchart showing a method of driving lamps by means of the lamp driving device without feedback control according to one exemplary embodiment of the present invention;

FIG. 13 is a circuit diagram showing a lamp driving device of a backlight assembly according to a third exemplary embodiment of the present invention;

FIG. 14 is a circuit diagram showing a lamp-current detecting part of FIG. 13;

FIG. 15 is a circuit diagram showing a feedback controller of FIG. 13;

FIG. 16 is a circuit diagram showing a lamp driving device of a backlight assembly according to a fourth exemplary embodiment of the present invention;

FIG. 17 is a circuit diagram showing a lamp-current detecting part of FIG. 16;

FIG. 18 is a flowchart showing a method of driving lamps by means of a floating type lamp driving device with feedback control according to another exemplary embodiment of the present invention;

FIG. 19 is a circuit diagram showing a lamp driving device of a backlight assembly according to a fifth exemplary embodiment of the present invention;

FIG. 20 is a circuit diagram showing a lamp driving device of a backlight assembly according to a sixth exemplary embodiment of the present invention; and

FIG. 21 is a flowchart showing a method of driving lamps by means of a ground type lamp driving device with feedback control according to another exemplary embodiment of the present invention.

### DESCRIPTION OF THE PREFERRED EMBODIMENTS

Hereinafter, a floating type fluorescent lamp driving method and a ground type fluorescent lamp driving method is explained briefly.

In general, when driving EIFLs, in which an external electrode is formed at one end of the glass tube, or EEFLs, in which an external electrode is formed at both ends of the glass tube, floating and ground type fluorescent lamp driving method is employed depending on a power supplying section, i.e. inverter, for applying an AC power signal to the lamps. When driving the lamps by applying the same lamp tube current thereto in both types of fluorescent lamp driving method, the voltage between both ends of each of the lamps is the same, as shown in table 2.

TABLE 2

| | Voltage between | Potential difference | Potential difference |
|---|---|---|---|
| | both ends of the | between (+) and (−) | between (+) and (−) |
| | lamp | in a hot electrode | in a cold electrode |
| Ground | 1000 V | 2000 V | 0 V |
| type | | | |
| Floating | 1000 V | 1000 V | 1000 V |
| type | | | |

Hereinafter the preferred embodiment of the present invention will be described in detail with reference to the accompanying drawings.

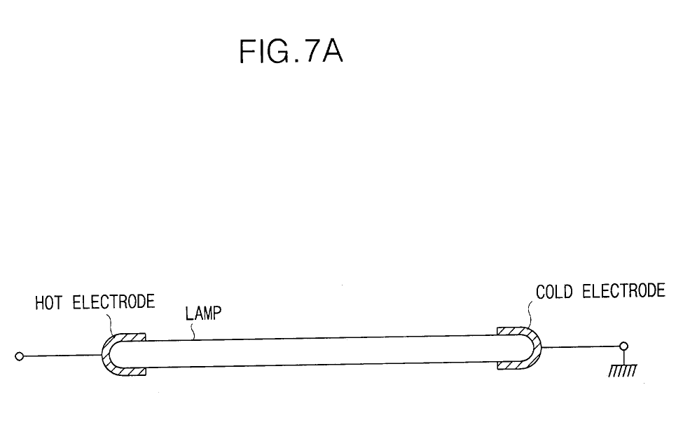

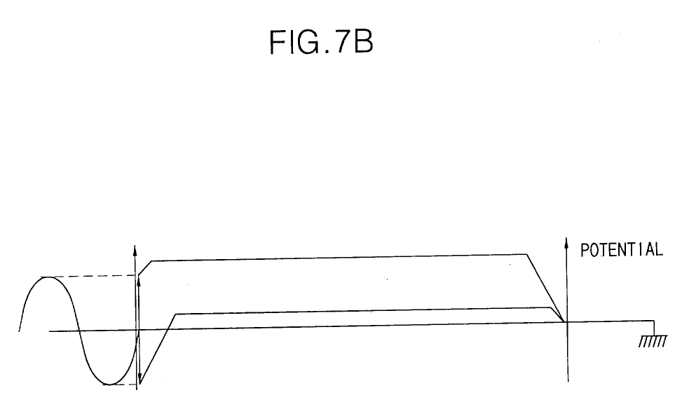

FIG. 7A is a schematic view showing a ground type fluorescent lamp, and FIG. 7B is a graph showing a potential difference between both ends of the EEFL in the ground type fluorescent lamp.

Referring FIG. 7B, voltage between both ends of the EEFL in the ground type fluorescent lamp is the. same as that in the floating type fluorescent lamp. However, when an AC power signal is applied to the electrodes and a plasma potential inside lamp tube is disregarded, the potential difference between (+) level and (−) level is twice the voltage between both ends of the EEFL in the hot electrode, and the potential difference between (+) level and (−) level in the cold electrode is 0 Volt.

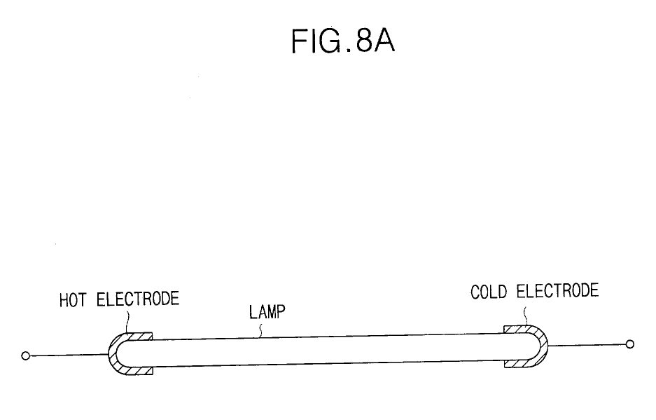

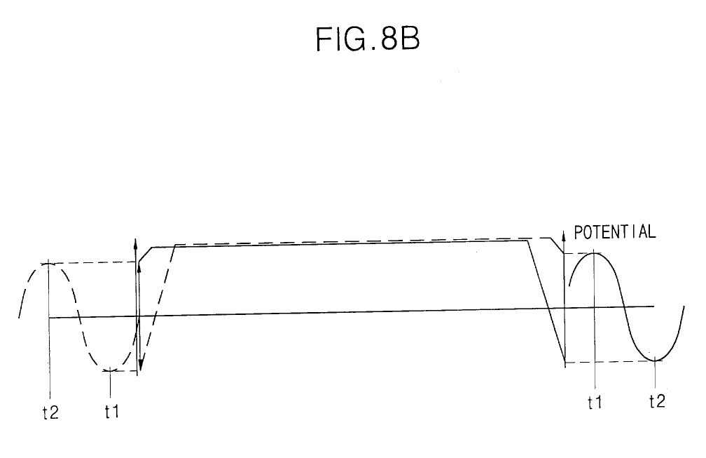

FIG. 8A is a schematic view showing a floating type fluorescent lamp, and FIG. 8B is a graph showing a potential difference between both ends of the EEFL in the floating type fluorescent lamp.

Referring to FIG. 8B, the voltage between both ends of the EEFL in the floating type fluorescent lamp is the same as that in the ground type fluorescent lamp. However, in both hot and cold electrodes, the potential difference between (+) level and (−) level is about the same as the voltage between both ends of the EEFL.

When a floating type inverter drives the EEFL, the endurance of the external electrode of the lamp increases.

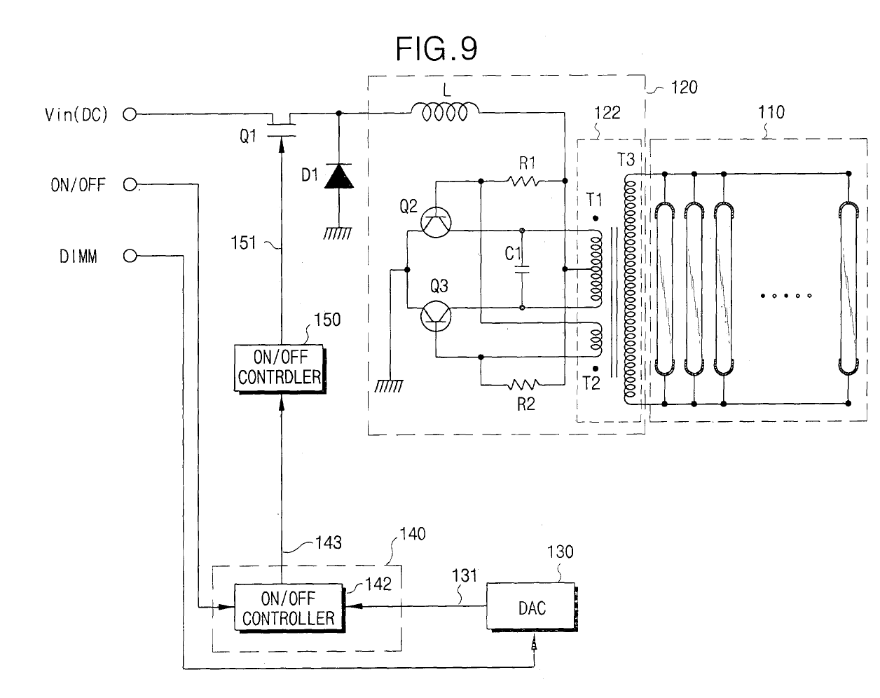

FIG. 9 is a circuit diagram showing a lamp driving device of a backlight assembly according to a first exemplary embodiment of the present invention.

Referring to FIG. 9, the lamp driving device according to the first exemplary embodiment of the present invention includes a power transistor Q1, a diode D1, an inverter 120, a digital-to-analogue converter (DAC) 130, a pulse width modulation (PWM) control part 140 and a power transistor driving part 150. The lamp driving device converts an external DC power signal into an AC power signal, and supplies the AC power signal to the lamp array 110, i.e. external electrode fluorescent lamps connected in parallel. The lamp driving device according to the first exemplary embodiment of the present invention can be used not only in the EEFL, in which an external electrode is formed at both ends of a lamp tube, but also in the EIFL (External Inner electrode Fluorescent Lamp), the EIFL having external electrodes at one end of a lamp tube and an inner electrode at the other end of the lamp tube. Although not shown in FIG. 9, a ballast capacitor can be inserted at one end of the lamps or at both ends of the lamps.

The power transistor Q1 is turned on in response to a switching signal input through a gate thereof, has a source for receiving an DC power signal, and a drain for outputting a pulse power signal to the inverter 120. The pulse power signal is a power signal that swings between a zero voltage level and the voltage level of the DC power signal.

A cathode of the diode D1 is connected to the drain of the power transistor Q1, and an anode of the diode D1 is connected to a ground, so that the diode D1 prevents a rush current from the inverter 120 from flowing into the power transistor Q1.

The inverter 120 includes an inductor L, a transformer 122, a resonant capacitor C1, first and second resistors R1 and R2 and first and second transistors Q2 and Q3. A first end of the inverter 120 is connected to the drain of the power transistor Q1. The inverter 120 converts the pulse power signal outputted from the power transistor Q1 into an AC power signal, and provides each of the lamps in the lamp array 110 with the converted AC power signal. For example, the inverter 120 may be a resonance type royer inverter.

More particularly, a first end of the inductor L is connected to the drain of the power transistor Q1, removes impulse from the pulse power signal, and outputs the impulse-removed power signal through the second end of the inductor L. The inductor L accumulates electromagnetic energy, returns and averages a counter electromotive force back to the diode D1 during a turn-off period of the power transistor Q1, i.e. serves as a kind of switching regulator.

The transformer 122 includes first and second coils T1 and T2 and a third coil T3. The first and second coils T1 and T2 correspond to a primary coil, and the third coil T3 corresponds to a secondary coil. The AC power signal that is applied to the first coil T1 through the inductor L is transmitted to the third coil T3 by an electromagnetic induction, and is converted into a high voltage AC signal. The converted high voltage AC signal is applied to the lamp array 110. The first coil T1 receives the AC power signal from the inductor L through a center tap.

The second coil T2 turns on selectively one of the first and second transistors Q2 and Q3 in response to the AC power signal applied to the first coil T1.

The resonant capacitor C1 is connected in parallel to both ends of the first coil T1 to make an LC resonance circuit together with an inductance of the first coil T1.

A base of the first transistor Q2 is connected to the inductor L through the first resistor R1 and receives the AC power signal through the resistor R1. A collector of the first transistor Q2 is connected to a first end of the resonant capacitor C1 and a first end of the first coil T1 to drive the transformer 122. A base of the second transistor Q3 is connected to the inductor L through the second resistor R2. A collector of the second transistor Q3 is connected to a second end of the resonant capacitor C1 and a second end of the first coil T1 to drive the transformer 122. An emitter of the second transistor Q3 is connected to the emitter of the first transistor Q2 and is commonly connected to the ground.

The DAC 130 converts an external dimming signal (DIMM) into an analog signal, and outputs the converted analog dimming signal to the PWM control part 140. The dimming signal is inputted by a user so as to control the brightness of the lamp, and has a constant duty value as a digital value.

The PWM control part 140 may be an on/off controller. The PWM control part is turned on or off by an external on/off control signal, and provides the power transistor driving part 150 with a switching signal 143, which controls the voltage level of the AC power signal provided to each of the lamps, in response to the converted analog dimming signal. The PWM control part 140 can further includes an oscillator (not shown) so as to provide an oscillating signal to the on/off controller 142 without oscillation function.

The power transistor driver 150 amplifies the signal 143 that controls the voltage level of the AC power signal provided from the PWM control part 140, and provides the power transistor Q1 with the amplified signal 151. In other words, the signal outputted from the PWM control part 140 has a low voltage level that is not enough to be applied to the power transistor Q1, so that the power transistor driver is employed so as to amplify the low voltage level signal.

Hereinafter, the power supplying part is described in detail. The power supplying part, i.e. the inverter 120, converts an AC signal having a low voltage level into an AC signal having a high voltage level.

The pulse power signal that is converted by the power transistor Q1 is applied to the base of a first transistor Q2 through the first resistor R1. Both ends of the first coil T1 are connected in parallel to a collector of each of the first and second transistors Q2 and Q3 of which emitter is connected to the ground, and the capacitor C1 is connected in parallel to collector of each of the first and second transistors Q2 and Q3.

The pulse power signal is applied to the center tap of first coil T1 of the transformer 122 through the inductor L. The inductor L includes a choke coil that converts the current provided to the inverter 120 into a constant current.

The third coil T3 has more winding number than the first coil T1 so as to raise the voltage level. The plurality of lamps in the lamp array is connected in parallel to the third coil T3 of the transformer 122 to provide each of the fluorescent lamps with a constant voltage. The constant voltage has a positive peak value and a negative peak value, and the negative peak value can has the same magnitude as the positive peak value, or an interval between the negative peak and the positive peak can be constant.

A first end of the second coil T2 of the transformer 122 is connected to the base of the first transistor Q2. A second end of the second coil T2 is connected to the base of the second transistor Q3. The second coil T2 provides the bases of each of the first and second transistors Q2 and Q3 with a voltage applied to the second coil T2.

Hereinafter, the operation of the inverter 120 is described in detail.

First, when the pulse power signal is applied to the inverter 120, a current flows into the first coil T1 of the transformer 122 through the inductor L, and simultaneously the pulse power signal is applied to the base of the first transistor Q2 through the first resistor R1 and the pulse power signal is applied to the base of the second transistor Q3 through the second resistor R2. A resonance circuit is formed by the reactance of the first coil T1 and the resonant capacitor C1.

Accordingly, at the secondary coil, i.e. between both ends of the third coil T3, a raised voltage is generated by a turn ratio, which means (T3's winding number)/ (T1's winding number). At the same time, at the primary coil of the transformer 122, i.e. at the second coil T2, a current of the second coil T2 flows in a reverse direction to the current direction of the first coil T1.

Then, a voltage level is raised at the third coil T3 by the turn ratio of (T3's winding number)/(T1's winding number), and a high voltage signal having a frequency and phase synchronized with the voltage signal of the primary coil. Accordingly, the flickering phenomenon can be prevented.

According to the first exemplary embodiment of the present invention, a plurality of EEFLs is connected in parallel so as to drive the backlight assembly having the EEFLs. However, EIFLs may replace the EEFLs, or a plurality of EIFLs may be connected in parallel so as to drive the backlight assembly having the EIFLs. Also, EIFLs and EEFLs may be used together to be connected in parallel with each other in a lamp array.

According to the first exemplary embodiment of the present invention, when a plurality of EEFLs connected in parallel are driven by the floating type lamp driving method, the luminance level of the fluorescent lamp can be controlled by providing an AC power signal of a constant voltage level to both ends of the fluorescent lamp in response to the external dimming signal.

In addition, even though one fluorescent lamp is broken and cannot operate normally, the other fluorescent lamps are not affected by the broken fluorescent lamp because the voltage level between both ends of the fluorescent lamps is constantly maintained. In other words, except that all the fluorescent lamp connected in parallel is broken, a lamp tube current flows to form a closed current through at least one fluorescent lamp, so that the danger of the fire due to the leakage of current can be removed.

Hereinafter, the effects of the present invention is described by comparing the backlight assembly having a lamp driving device for driving the EEFLs with the backlight assembly having a lamp driving device for driving the conventional CCFLs.

TABLE 3

| | Direct illuminating | |
|---|---|---|
| | type CCFL module | EEFL module |
| Luminance | 450 nits (or cd/m²) | |
| Color coordinate | [0.268, 0.306] | [0.288, 0.344] |
| 8 x, y] | | |
| Uniformity of | 75% | |
| luminance | | |
| Panel | 3.74% | |
| transmissivity | | |
| Contrast | 472.3 | 527.3 |
| Power | 31 watts | 31 watts; |
| consumption | | 33 watts in case of |
| | | compensated color |
| | | coordinate |
| Power supplying | Serially connected lamps | Parallel connected lamps |
| part (Inverter) | 65 kHz | 65 kHz |
| | Ground type | Floating type |

The backlight assembly having EEFLs connected in parallel according to the present invention has power consumption increased by 2 watts when the color coordinate of the EEFL module is compensated so as to be the same color coordinate as that of the backlight assembly having CCFLs, but this is not significant.

The backlight assembly having EEFLs connected in parallel of the present invention, as shown in Table 3, has a contrast higher than the direct illuminating type CCFL module, and has the same light efficiency (luminance/power consumption) as the direct illuminating type CCFL module. The EEFLs module can be employed for the backlight assembly at a lower price than the direct illuminating type CCFL module.

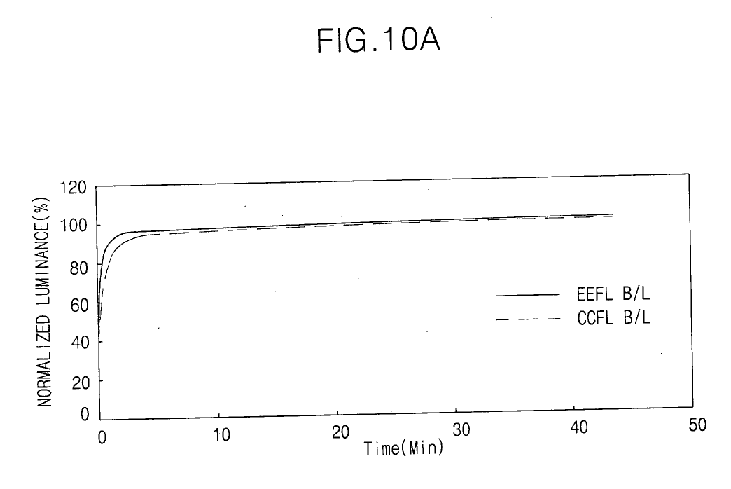

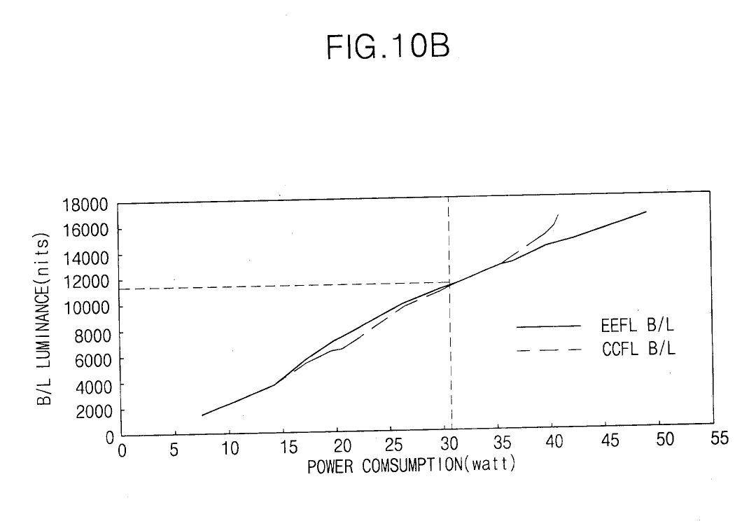

FIGS. 10A and 10B is a graph showing difference in luminance and light efficiency characteristics between a backlight assembly having EEELs and a backlight assembly having a CCFL.

Referring to FIG. 10A, the backlight assembly having EEFLs has the same characteristics of normalized luminance as that of the backlight assembly having CCFLs after 2 or 3 minutes, but the backlight assembly having EEFLs has an enhanced characteristic of normalized luminance compared with that of the backlight assembly having CCFLs directly after the EEFLs are turned on. In other words, the backlight assembly having EEFLs has an enhanced characteristic of luminance saturation compared with that of the backlight assembly having CCFLs.

Referring to FIG. 10B, the backlight assembly having EEFLs according to the first exemplary embodiment of the present invention has a similar characteristic of light efficiency compared with that of the backlight assembly having CCFLs.

As shown in Table 3, FIGS. 10A and 10B, the backlight assembly may employs the EEFLs because the EEFLs has a lower price than the CCFLs, and even though the backlight assembly does not employ any feedback control method, the backlight assembly employing EEFLs has not significant different characteristics of luminance uniformity, light efficiency and luminance saturation compared with the backlight assembly employing CCFLs.

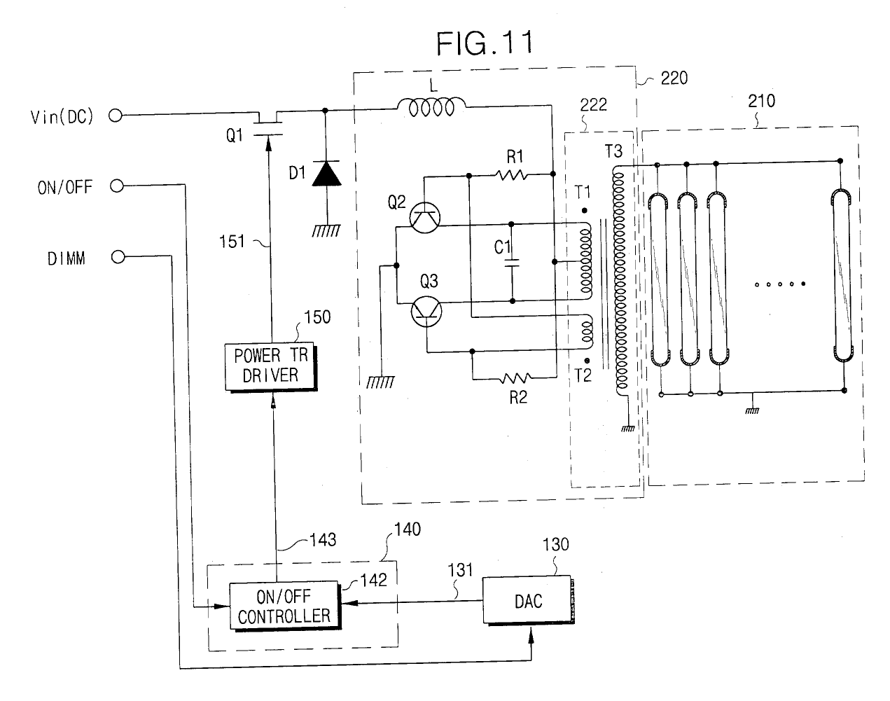

FIG. 11 is a circuit diagram showing a lamp driving device of a backlight assembly according to a second exemplary embodiment of the present invention, especially shows a ground type lamp driving device without feedback function.

Referring to FIG. 11, the lamp driving device according to the second exemplary embodiment of the present invention includes a power transistor Q1, a diode D1, an inverter 220, a digital-to-analogue converter DAC 130, a PWM control part 140 and a power transistor driving part 150. The lamp driving device converts external DC power signal into AC power signal, and supplies the AC power signal to the lamp array 210, i.e. external electrode fluorescent lamps connected in parallel. Hereinafter, like reference numerals identify similar or identical elements, and detailed descriptions about the identical elements will be omitted.

Compared with FIG. 9, the differences are as followings. A first end of the third coil T3, which is a secondary coil of the transformer 222 in the inverter 220, is connected to the ground. Also, each of the hot electrodes is commonly connected with each other and receives a raised AC power signal from the inverter 220, and all the cold electrodes is commonly connected to the ground.

According to the second exemplary embodiment of the present invention, when a plurality of EEFLs or EIFLs connected in parallel are driven by the ground type lamp driving method, the luminance level of the fluorescent lamp can be controlled by providing an AC power signal of a constant voltage level to one end of the fluorescent lamp in response to an external dimming signal.

In addition, even though one fluorescent lamp is broken and cannot operate normally, the other fluorescent lamps are not affected by the broken fluorescent lamp because the voltage level between both ends of the fluorescent lamps is constantly maintained. In other words, except all the fluorescent lamp connected in parallel is broken, a lamp tube current flows to form a closed current through at least one fluorescent lamp, so that the danger of the fire due to the leakage of current can be removed.

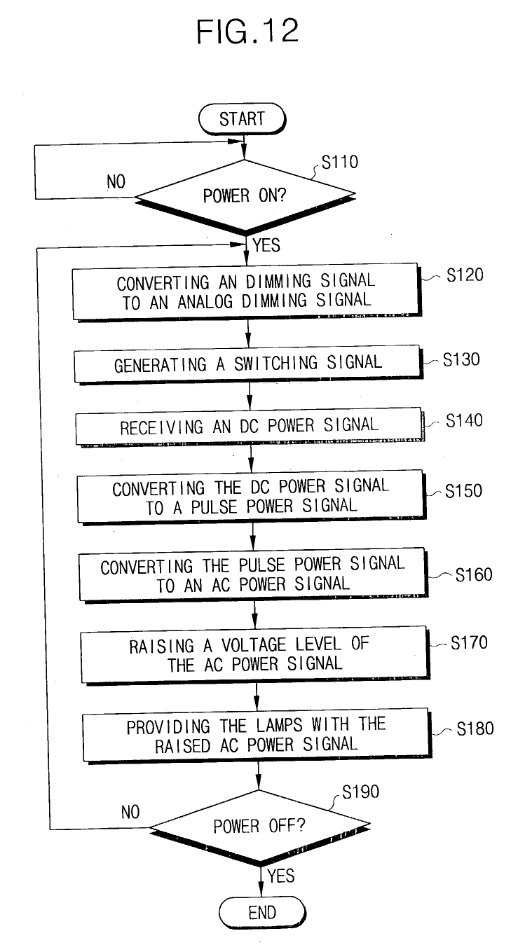

FIG. 12 is a flowchart showing a method of driving lamps by means of the lamp driving device without feedback control according to one exemplary embodiment of the present invention, especially shows procedures for supplying power signal to the lamps before/after the voltage level is raised by the transformer by means of the lamp driving device without feedback function according to FIGS. 9 and 11.

Referring to FIG. 12, a power signal is supplied to the lamp driving device so as to turn on the lamps of the backlight assembly (step S110). The lamp driving device converts an dimming signal into an analog dimming signal (step S120), generates a switching signal based on the converted analog dimming signal (step S130), and receives an external DC power signal (step S140).

Then, the lamp driving device converts the DC power signal into a pulse power signal (step S150), and converts the pulse power signal into an AC power signal (step S160). The power transistor Q1 is turned on in response to a switching signal input through a gate thereof, and has a source for receiving a DC power signal, and a drain for outputting a pulse power signal to the inverter 220. The pulse power signal is a power signal that swings between a ground voltage level and the voltage level of the DC power signal.

Then, the lamp driving device raises the voltage level of the AC power signal (step S170), and provides both ends of the lamps or one end of the lamps (step S180) with the raised AC power signal. As shown in FIG. 9, the secondary coil of the transformer 122 is connected to both ends of each of the lamps, the voltage level of the AC power signal is raised by the transformer 122, and the raised AC power signal is provided to both ends of each of the lamps. As shown in FIG. 11, one end of the secondary coil of the transformer 222 is connected to one end of each of the lamps and the other end of the secondary coil of the transformer 222 is connected to the ground, the voltage level of the AC power signal is raised by the transformer 222, and the raised AC power signal is provided to the hot electrode of each of the lamps.

Next, the lamp driving device checks whether or not the power is turned off (step S190). If the power is off, the lamp driving device finishes lamp driving operation. If the power is turned on, the lamp driving device repeatedly performs step S1 20 to provide the lamps with the raised AC power signal.

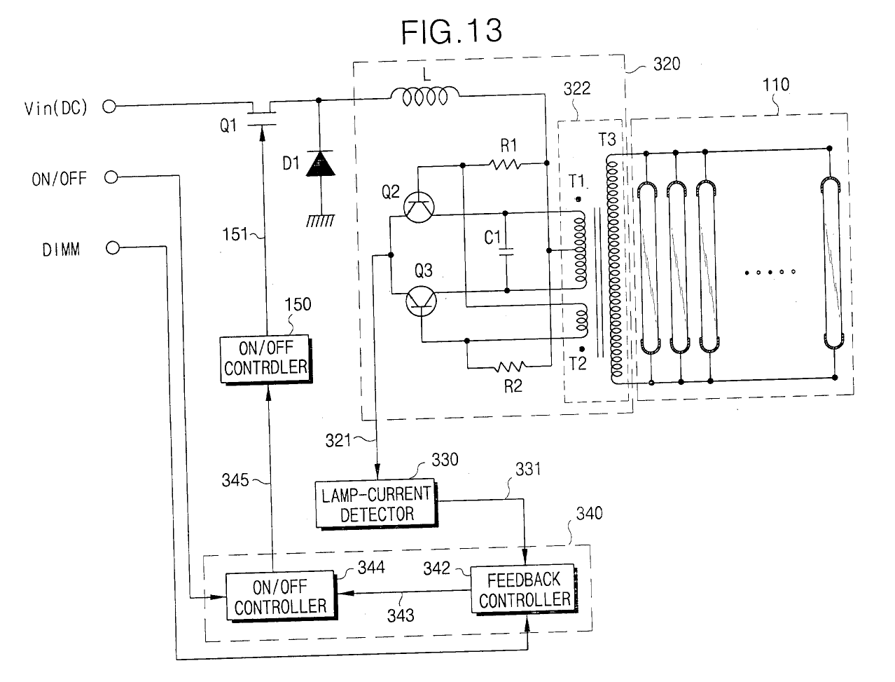

FIG. 13 is a circuit diagram showing a lamp driving device of a backlight assembly according to a third exemplary embodiment of the present invention, especially shows a floating type lamp driving device that detects a lamp current from the input terminal of the transformer.

Referring to FIG. 13, the lamp driving device according to a third exemplary embodiment of the present invention includes a power transistor Q1, a diode D1, an inverter 220, a lamp-current detecting part 330, a pulse width modulation (PWM) control part 340 and a power transistor driving part 150. The lamp driving device converts an external DC power signal into an AC power signal, and supplies the AC power signal to the lamp array 110, i.e. lamps connected in parallel. Hereinafter, compared with FIG. 9, like reference numerals identify similar or identical elements, and detailed descriptions about the identical elements will be omitted.

The inverter 320 includes an inductor L, a transformer 322, a resonant capacitor C1, first and second resistors R1 and R2 and first and second transistors Q2 and Q3. A first end of the inverter 320 is connected to the drain of the power transistor Q1. The inverter 320 converts the pulse power signal outputted from the power transistor Q1 into an AC power signal, and provides each of the lamps in the lamp array 110 with the converted AC power signal. For example, the inverter 320 may be a resonance type royer inverter.

A base of the first transistor Q2 is connected to the inductor L through the first resistor R1 and receives the AC power signal through the resistor R1, and a collector of the first transistor Q2 is connected to a first end of the resonant capacitor C1 and a first end of the first coil T1 to drive the transformer 322.

A base of the second transistor Q3 is connected to the inductor L through the second resistor R2. A collector of the second transistor Q3 is connected to a second end of the resonant capacitor C1 and a second end of the first coil T1 to drive the transformer 322. An emitter of the second transistor Q3 is connected to the emitter of the first transistor Q2 and is commonly connected to the ground.

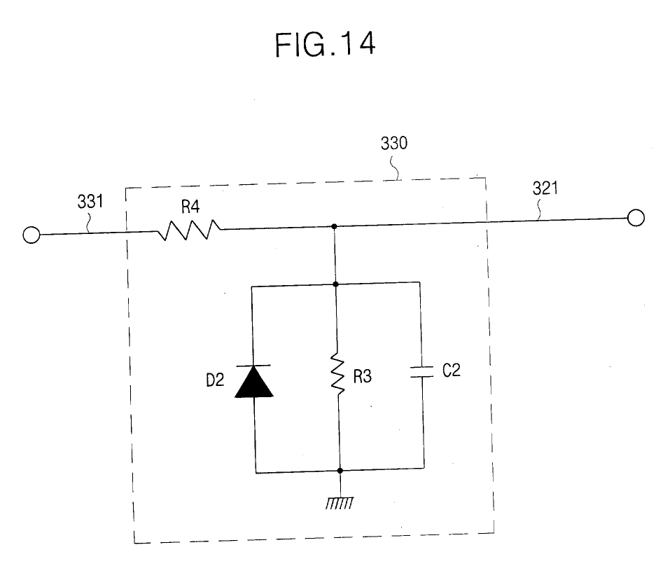

The lamp-current detecting part 330 rectifies an AC signal 321 inputted from the emitters of the transistors Q2 and Q3 to convert the AC signal 321 into a DC signal 331, and outputs the DC signal 331 to a PWM control part 340. A specific circuit of the lamp-current detecting part 330 is described in FIG. 14.

The PWM control part 340 includes a feedback controller 342 and an on/off controller 344, is turned on or off by an external on/off control signal, and provides the power transistor driving part 150 with a switching signal 345, which controls the voltage level of the AC power signal provided to each of the lamps, in response to an analog dimming signal. The PWM control part 340 controls a pulse width in correspondence with an output error to output a regulated output voltage. For example, the PWM control part 340 may be an IC (Integrating Circuit) chip.

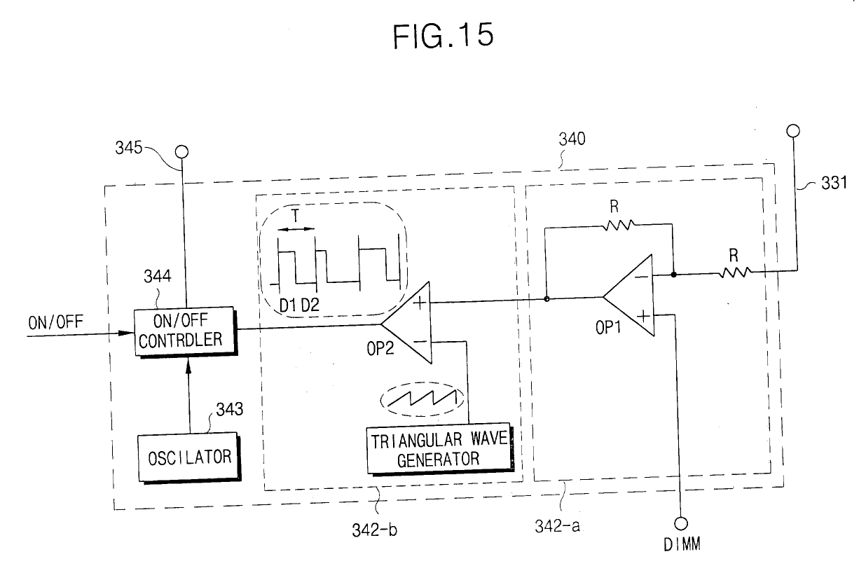

Also, a feedback controller 342 is necessary for regulating the output voltage, and an exemplary specific circuit of the feedback controller 342 is shown in FIG. 15.

A power transistor driver 150 amplifies a signal 345 that controls the voltage level of the AC power signal provided from the PWM control part 340, and provides the power transistor Q1 with the amplified signal 151.

FIG. 14 is a circuit diagram showing a lamp-current detecting part of FIG. 13.

Referring to FIG. 14, the lamp-current detecting part 330 includes a second capacitor C2, a third resistor R3, a second diode D2, and a fourth resistor R4. A first end of the second capacitor C2 is connected to the ground, and the second end of the second capacitor C2 is connected to the emitters of the transistors Q2 and Q3 through the fourth resistor R4. The third resistor R3 is connected in parallel to both ends of the second capacitor C2, and the second diode D2 is connected in parallel to both ends of the second capacitor C2. A first end of the fourth resistor R4 is connected to a second end of the second diode D2. A second end of the fourth resistor R4 is connected to the PWM control part 340 to output the detected lamp current to the fourth resistor R4.

When the AC signal 321 is inputted from the emitters of the transistors Q2 and Q3, the AC signal 321 is rectified by the capacitor C2, the resistor R3 and the diode D2 to be converted into a DC signal 331, and the DC signal 331 is applied to the feedback controller 340 through the fourth resistor R4.

FIG. 15 is a circuit diagram showing a feedback controller of FIG. 13.

Referring to FIG. 15, the DC signal 331 outputted from the lamp-current detecting part 330 is inputted to a non-inverting terminal of the first operational amplifier OP1, and compared with the reference signal, i.e. the dimming signal DIMM. The error between the dimming signal and the DC signal 331 is amplified through an error amplifier 342-a, and is compared with a triangular wave to be a square wave. The square wave is inputted to the on/off controller 344. The PWM controller 340 further includes an oscillator 343 so as to provide the on/off controller 344 with an oscillating signal without oscillation function.

According to the third exemplary embodiment of the present invention, when a plurality of EEFLs or EIFLs connected in parallel are driven by the floating type lamp driving method, the lamp current of the fluorescent lamp is indirectly detected by means of the primary coil of the transformer, the luminance level of the fluorescent lamp can be controlled by providing an AC power signal of a constant current level to both ends of the fluorescent lamp in response to the detected lamp current and the external dimming signal.

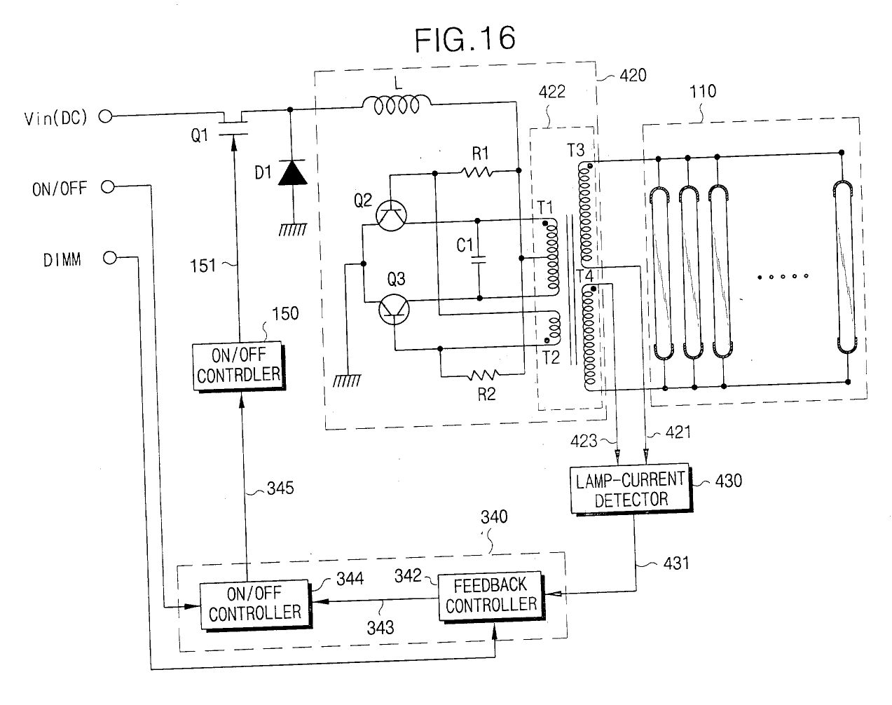

FIG. 16 is a circuit diagram showing a lamp driving device of a backlight assembly according to a fourth exemplary embodiment of the present invention, and especially shows a floating type lamp driving device that detects lamp current from the output terminal of the transformer.

Referring to FIG. 16, the lamp driving device according to a fourth exemplary embodiment of the present invention includes a power transistor Q1, a diode D1, an inverter 420, a lamp-current detecting part 430, a pulse width modulation (PWM) control part 340 and a power transistor driving part 150. The lamp driving device converts an external DC power signal into an AC power signal, and supplies the AC power signal to the lamp array 110, i.e. external electrode fluorescent lamps connected in parallel. Hereinafter, compared with FIGS. 9 and 13, like reference numerals identify similar or identical elements, and detailed descriptions about the identical elements will be omitted.

The inverter 420 includes an inductor L, a transformer 422, a resonant capacitor C1, first and second resistors R1 and R2 and first and second transistors Q2 and Q3. A first end of the inverter 420 is connected to the drain of power transistor Q1. The inverter 320 converts the pulse power signal outputted from the power transistor Q1 into an AC power signal, and provides each of the lamps in the lamp array 110 with the converted AC power signal. For example, the inverter 420 may be a resonance type royer inverter.

The transformer 122 includes first and second coils T1 and T2 and third and fourth coils T3 and T4. The first and second coils T1 and T2 correspond to a primary coil, and the third and fourth coils T3 correspond to a secondary coil. The AC power signal that is applied to the first coil T1 through the inductor L is transmitted to the third and fourth coils T3 and T4 by an electromagnetic induction, and is converted into a high voltage AC signal. The converted high voltage AC signal is applied to the lamp array 110. The third coil T3 has the same winding direction as the fourth coil T4. Accordingly, the third coil T3 is regarded as being serially connected with the fourth coil T4.

The first coil T1 receives the AC power signal from the inductor L through a center tap, and transmits the AC power signal to the secondary coil, i.e. the third and fourth coils T3 and T4 by the electromagnetic induction.

The second coil T2 selectively turns on one of the transistors Q2 and Q3 in response to the AC power signal applied to the first coil T1.

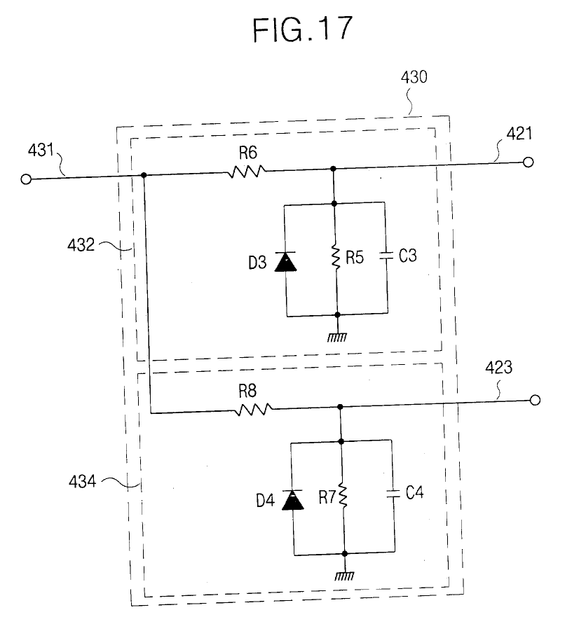

FIG. 17 is a circuit diagram showing a lamp-current detecting part of FIG. 16.

Referring to FIG. 17, the lamp-current detecting part 430 includes a hot electrode-current detecting part 432 and a cold electrode-current detecting part 434. The lamp-current detecting part 430 detects the currents 421 and 423 applied to the hot and cold electrodes of the lamps, and outputs a lamp current detecting signal 431.

Particularly, the hot electrode-current detecting part 432 includes a third capacitor C3, a fifth resistor R5, a third diode D3, and a sixth resistor R6. A first end of the third capacitor C3 is connected to the ground, and a second end of the third capacitor C3 is connected to a second end of the third coil T3. The fifth resistor R5 is connected in parallel to both ends of the third capacitor C3, and the third diode D3 is connected in parallel to both ends of the third capacitor C3. A first end of the sixth resistor R6 is connected to a second end of the third diode D3, and a second end of the sixth resistor R6 is connected to the PWM control part 340 to output the detected lamp current to the sixth resistor R6.

Also, the cold electrode-current detecting part 434 includes a fourth capacitor C4, a seventh resistor R7, a fourth diode D4, and an eighth resistor R8. A first end of the fourth capacitor C4 is connected to the ground. A second end of the fourth capacitor C4 is connected to a second end of the third coil T3. The seventh resistor R7 is connected in parallel to both ends of the fourth capacitor C4. The fourth diode D4 is connected in parallel to both ends of the fourth capacitor C4. A first end of the eighth resistor R8 is connected to a second end of the fourth diode D4, and a second end of the eighth resistor R8 is connected to the PWM control part 340 to output the detected lamp current to the eighth resistor R8.

When the raised AC power signal is inputted to the hot electrode-current detecting part 432 from the third coil T3, the raised AC power signal is rectified by the third capacitor C3, the fifth resistor R5 and the third diode D3 to be converted into a raised DC power signal, and the raised DC power signal is applied to the PWM control part 340 through the sixth resistor R6. Also, when the raised AC power signal is inputted to the cold electrode-current detecting part 434 from the fourth coil T4, the raised AC power signal is rectified by the fourth capacitor C4, the seventh resistor R7 and the fourth diode D4 to be converted into a raised DC power signal, and the raised DC power signal is applied to the PWM control part 340 through the eighth resistor R6.

According to the fourth exemplary embodiment of the present invention, when a plurality of EEFLs or EIFLs connected in parallel are driven by the floating type lamp driving method, the lamp current of the fluorescent lamp is directly detected by means of the secondary coil of the transformer in the inverter, the luminance level of the external electrode fluorescent lamp can be controlled by providing an AC power signal of a constant current level to both ends of the fluorescent lamp in response to the detected lamp current and the external dimming signal.

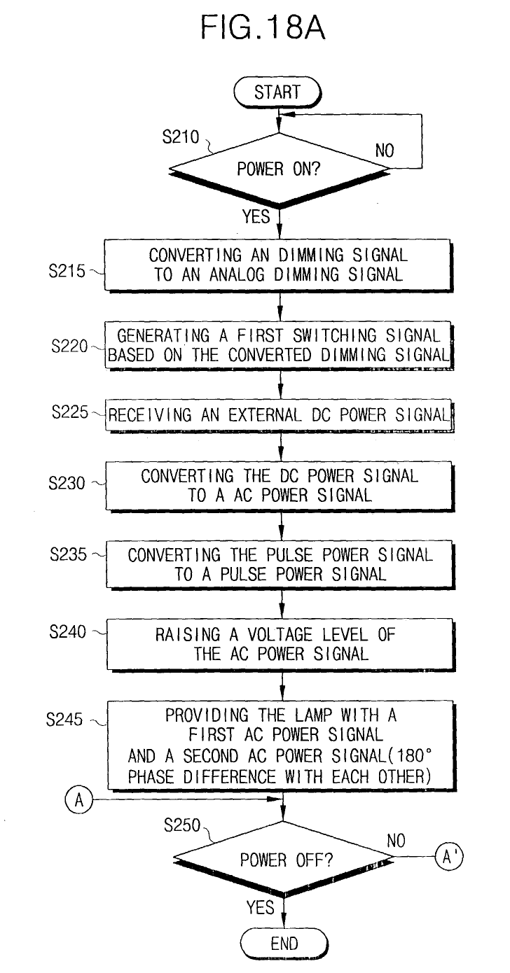

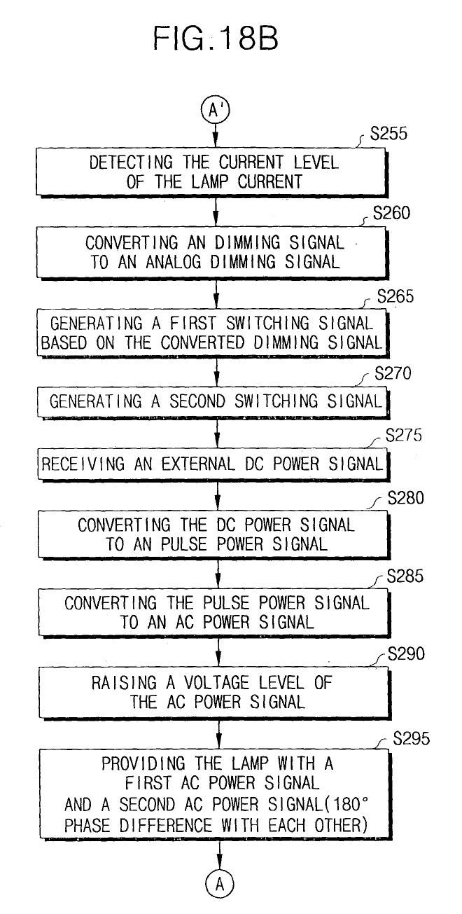

FIG. 18 is a flowchart showing a method of driving lamps by means of a floating type lamp driving device with feedback control according to another exemplary embodiment of the present invention. FIG. 18 especially shows procedures for supplying power signal to the lamps before/after the voltage level is raised by the transformer by means of the lamp driving device with feedback function according to FIGS. 13 and 16.

Referring to FIG. 18, a power signal is supplied to the lamp driving device so as to turn on the lamps of the backlight assembly (step S210). The lamp driving device converts an dimming signal inputted by a user into an analog dimming signal (step S215), generates a first switching signal based on the converted analog dimming signal (step S220), and receives an external DC power signal (step S225).

Then, the lamp driving device converts the DC power signal into a pulse power signal (step S230), and converts the pulse power signal into an AC power signal (step S235).

The lamp driving device raises a voltage level of the converted AC power signal (step S230) to a first AC power signal and a second AC power signal. The first AC power signal has a phase difference of about 180° with the second AC power signal. The lamp driving device provides both ends of the lamps (step S245) with the first AC power signal and the second AC power signal. As shown in FIG. 13, the secondary coil of the transformer 322 is connected to both ends of each of the lamps, the voltage level of the AC power signal is raised by the transformer 322. The raised first AC power signal is provided to one ends (for example, hot electrodes) of each of the lamps, and the raised second AC power signal is provided to the other ends (for example, cold electrodes) of each of the lamps.

As shown in FIG. 16, one end of the secondary coil—i.e. a third coil T3—of the transformer 422 is connected to one end (for example, hot electrodes) of each of the lamps and the other end—i.e. a fourth coil T4—of the secondary coil of the transformer 422 is connected to the other end (for example, cold electrodes) of each of the lamps, the voltage level of the AC power signal is raised by the transformer 422, and the raised AC power signal is provided to the both ends of each of the lamps.

Next, the lamp driving device checks whether or not the power is off (step S250). If the power is off, the lamp driving device finishes lamp driving operation. If the power is on, the lamp driving device detects the current level of the lamp current (step S255). The lamp driving device can detect the current level of the lamp current before the voltage level is raised by the transformer. In other words, the lamp driving device can detect the current level of the input terminals of the transformer 322. Also, the lamp driving device can detect the current level of the lamp current after the voltage level is raised by the transformer. In other words, the lamp driving device can detect the current level of the output terminals of the transformer 322.

Next, the lamp driving device converts the dimming signal into an analog dimming signal (step S260), and generates a first switching signal based on the analog dimming signal (step S265). The first switching signal is different from the first switching signal that is generated at the step of S220 because the first switching signal of S220 becomes the first switching signal of S265 after a predetermined time period passes.

Next, the lamp driving device generates a second switching signal based on an external dimming signal and the first switching signal in the step S265 (step S270). Then, the lamp driving device receives an external DC power signal (step S275), converts the DC power signal into a pulse power signal (step S280), and converts the pulse power signal into an AC power signal (step S285).

Next, the lamp driving device raises a voltage level of the AC power signal (step S290) to a first AC power signal and a second AC power signal. The first AC power signal has a phase difference of about 180° with the second AC power signal. The lamp driving device provides both ends of the lamps (step S295) with the first and second AC power signals.

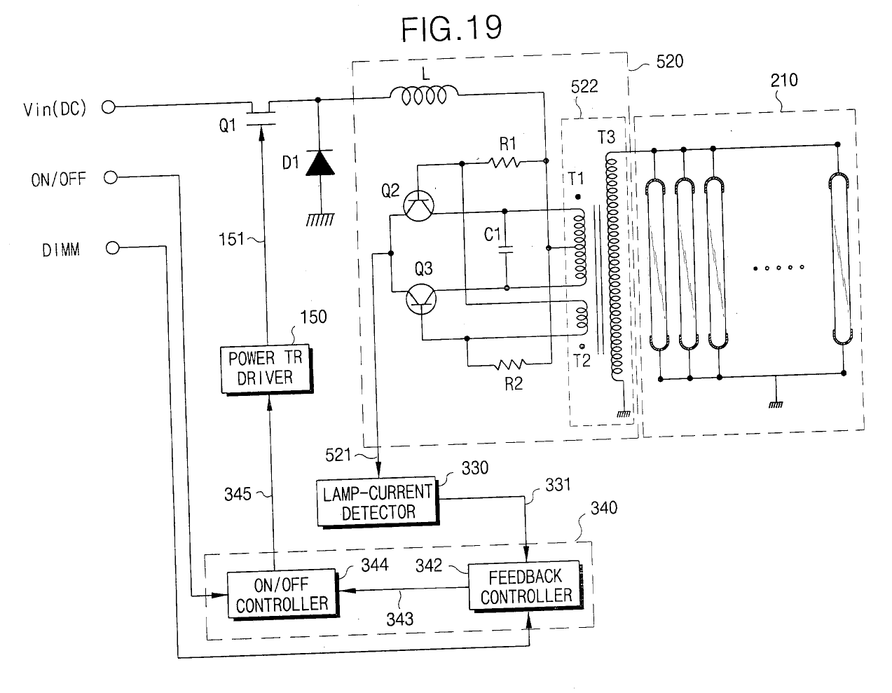

FIG. 19 is a circuit diagram showing a lamp driving device of a backlight assembly according to a fifth exemplary embodiment of the present invention, and especially shows a ground type lamp driving device that detects the current level of the lamp current at the input terminal of the transformer.

Referring to FIG. 19, the lamp driving device according to a fifth exemplary embodiment of the present invention includes a power transistor Q1, a diode D1, an inverter 520, a lamp-current detecting part 330, a pulse width modulation (PWM) control part 340 and a power transistor driving part 150. The lamp driving device converts an external DC power signal into an AC power signal, and supplies the AC power signal to the lamp array 210. Hereinafter, compared with FIGS. 9, 11 and 13, like reference numerals identify similar or identical elements, and detailed descriptions about the identical elements will be omitted.

The inverter 520 includes an inductor L, a transformer 522, a resonant capacitor C1, first and second resistors R1 and R2 and the first and second transistors Q2 and Q3, and a first end of the inverter 520 is connected to the drain of power transistor Q1. The inverter 520 converts the pulse power signal outputted from the power transistor Q1 into an AC power signal, and provides each of the lamps in the lamp array 210 with the converted AC power signal. For example, the inverter 520 may be a resonance type royer inverter. One end of a secondary coil of the transformer 522 is connected to the ground.

According to the fifth exemplary embodiment of the present invention, when a plurality of EEFLs or EIFLs connected in parallel are driven by the ground type lamp driving method, the lamp current of the fluorescent lamp is indirectly detected by means of the primary coil of the transformer, the luminance level of the fluorescent lamp can be controlled by providing an AC power signal of a constant current level to both ends of the fluorescent lamp in response to the detected lamp current and the external dimming signal.

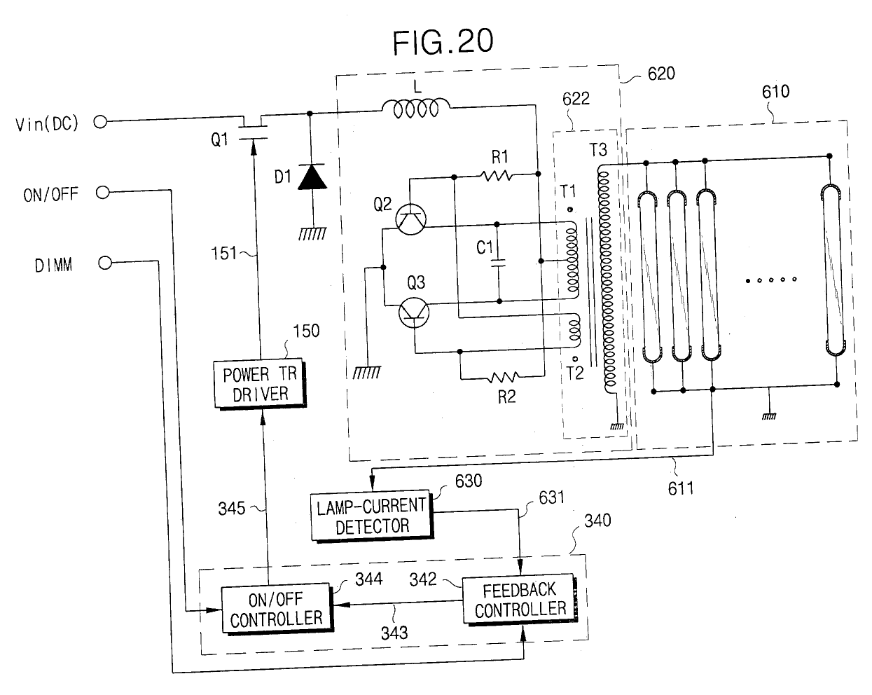

FIG. 20 is a circuit diagram showing a lamp driving device of a backlight assembly according to a sixth exemplary embodiment of the present invention, and especially shows a ground type lamp driving device that detects the current level of the lamp current at an end of the lamps that is connected to the ground.

Referring to FIG. 20, the lamp driving device according to a sixth exemplary embodiment of the present invention includes a power transistor Q1, a diode D1, an inverter 620, a lamp-current detecting part 630, a pulse width modulation (PWM) control part 340 and a power transistor driving part 150. The lamp driving device converts an external DC power signal into an AC power signal, and supplies the AC power signal to the lamp array 610. Hereinafter, compared with FIGS. 9, 11 and 13, like reference numerals identify similar or identical elements, and detailed descriptions about the identical elements will be omitted.

The inverter 620 includes an inductor L, a transformer 622, a resonant capacitor C1, first and second resistors R1 and R2 and first and second transistors Q2 and Q3, and a first end of the inverter 620 is connected to the drain of power transistor Q1. The inverter 520 converts the pulse power signal outputted from the power transistor Q1 into an AC power signal, and provides the converted AC power signal each of the lamps in the lamp array 610. For example, the inverter 620 may be a resonance type royer inverter. The transformer 622 operates the same as the transformer 522 of FIG. 19.

The lamp array 610 has a plurality of external electrode fluorescent lamps. Each of the first ends—i.e. for example, hot electrodes—of the external electrode fluorescent lamps is commonly connected to each other, and receives the raised AC power signal of a constant current level. Each of the other ends—i.e. for example, cold electrodes—of the external electrode fluorescent lamps are commonly connected to the ground, and are commonly connected to the lamp-current detecting part 630.

According to the sixth exemplary embodiment of the present invention, when a plurality of EEFLs or EIFLs connected in parallel are driven by the ground type lamp driving method, the total lamp currents of the fluorescent lamp are directly detected at the other ends of the lamps, the luminance level of the fluorescent lamp can be controlled by providing an AC power signal of a constant current level to both ends of the fluorescent lamp in response to the detected total lamp currents and the external dimming signal.

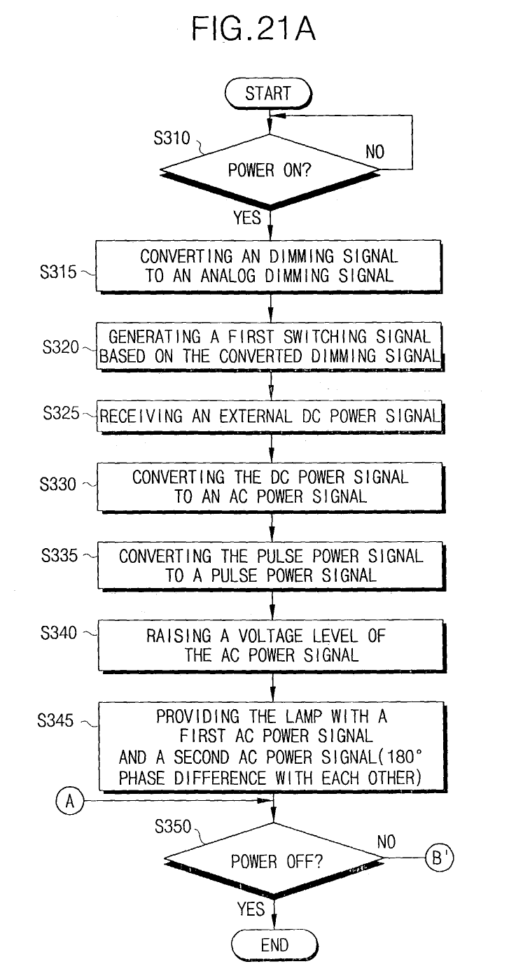

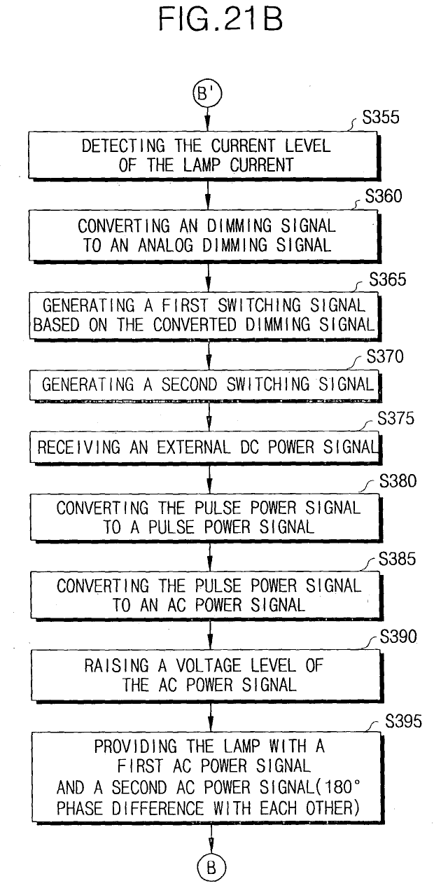

FIG. 21 is a flowchart showing a method of driving lamps by means of a ground type lamp driving device with feedback control according to another exemplary embodiment of the present invention, and especially shows procedures for supplying power signal to the lamps before/after the voltage level is raised by the transformer by means of the lamp driving device with feedback function according to FIGS. 19 and 20.

Referring to FIG. 21, a power signal is supplied to the lamp driving device so as to turn on the lamps of the backlight assembly (step S310). The lamp driving device converts an dimming signal inputted by a user into an analog dimming signal (step S315), generates a first switching signal based on the converted analog dimming signal (step S320), and receives an external DC power signal (step S325).

Then, the lamp driving device converts the DC power signal into a pulse power signal (step S330), and converts the pulse power signal into an AC power signal (step S335).

The lamp driving device raises a voltage level of the converted AC power signal (step S340), and provides one end of each of the lamps (step S345) with the raised AC power signal As shown in FIG. 19, one end of the secondary coil of the transformer 522 is connected to the ground, and the other end of the secondary coil of the transformer 522 is connected to one ends—for example, hot electrodes—of each of the lamps, the voltage level of the AC power signal is raised by the transformer 522. The raised AC power signal is provided to the hot electrodes of each of the lamps. As shown in FIG. 20, one end of the secondary coil of the transformer 622 is connected to the ground, and the other end of the secondary coil of the transformer 622 is connected to the one end of each of the lamps, the voltage level of the AC power signal is raised by the transformer 622, and the raised AC power signal is provided to the one ends—for example, hot electrodes—of each of the lamps.

Next, the lamp driving device checks whether the power is off (step S350). If the power is off, the lamp driving device finishes lamp driving operation. If the power is on, the lamp driving device detects the current level of the lamp current (step S355). The lamp driving device can detect the current level of the lamp current before the voltage level is raised by the transformer 522 of FIG. 19. In other words, the lamp driving device can detect the current level of the input terminals of the transformer 522. Also, the lamp driving device can detect the current level of the lamp current after the voltage level is raised by the transformer 622 of FIG. 20. In other words, the lamp driving device can detect the current level of the output terminals of the transformer 622.

Next, the lamp driving device converts the dimming signal into an analog dimming signal (step S360), and generates a first switching signal based on the analog dimming signal (step S365). The lamp driving device generates a second switching signal based on an external dimming signal and the first switching signal in the step S355 (step S370). The first switching signal is different from the first switching signal that is generated at the step S320 because the first switching signal of the step S320 becomes the first switching signal of the step S365 after a predetermined period passed.

Then, the lamp driving device receives an external DC power signal (step S375), converts the DC power signal into a pulse power signal (step S380), and converts the pulse power signal into an AC power signal (step S385).

Next, the lamp driving device raises a voltage level of the AC power signal to a first AC power signal and a second AC power signal (step S390), and provides one end of each of the lamps with the first and second AC power signals. (step S395).

Heretofore, the floating or ground type lamp driving devices, which is installed in the backlight assembly and drives a plurality of external electrode fluorescent lamps connected in parallel each other, according to various exemplary embodiments has been described.

However, the lamp driving device of the present invention can be employed to any backlight assembly that includes a lamp unit, a light emitting means and light regulating means. The lamp units include a plurality of external electrode fluorescent lamps connected in parallel. The light emitting means emits lights based on a raised AC power signal applied from the lamp driving device, and the light regulating means enhances the brightness of the light provided from the emitting means. When the light regulating means is employed in the direct illuminating type backlight assembly, the light regulating means may include a diffusion plate, a diffusion sheet, a low prism sheet, an upper prism sheet and a protection sheet, etc. The diffusion plate, a diffusion sheet, a low prism sheet, an upper prism sheet and a protection sheet are sequentially stacked on lamps that are received on a bottom chassis.

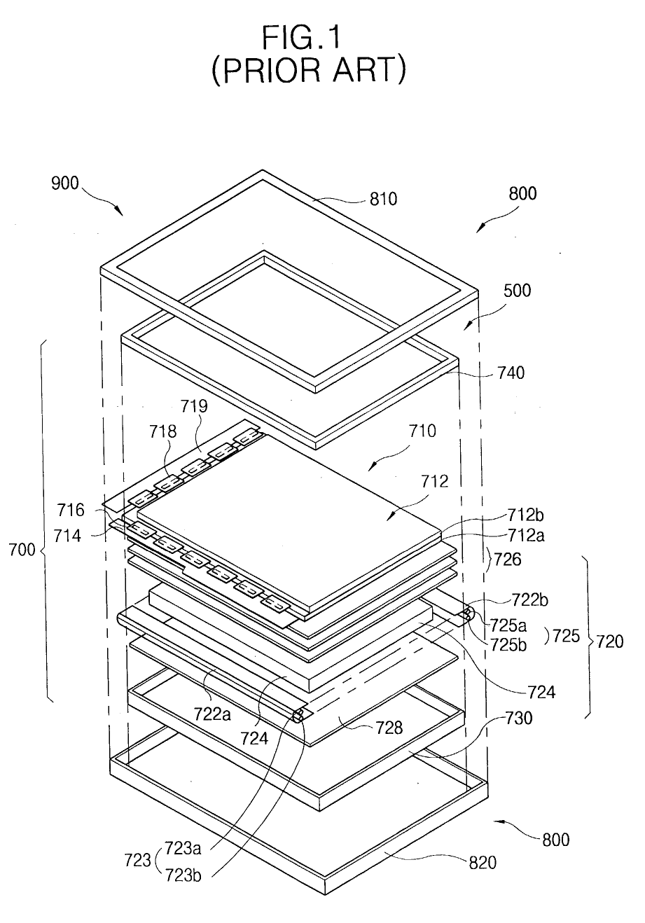

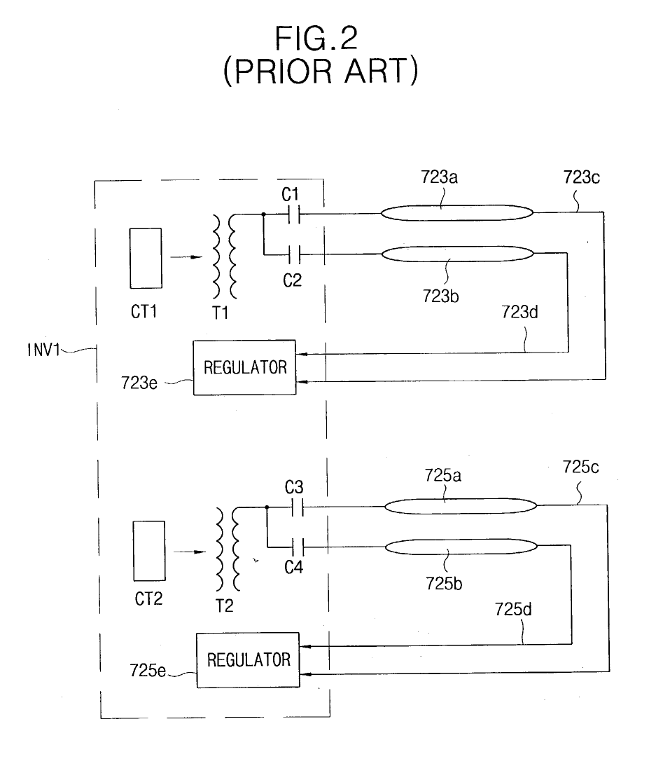

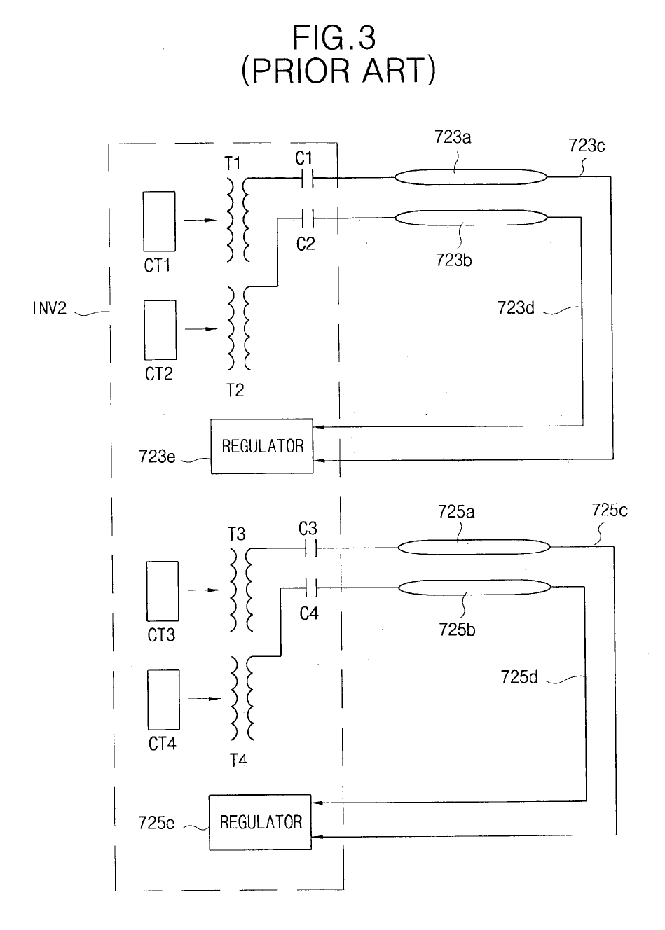

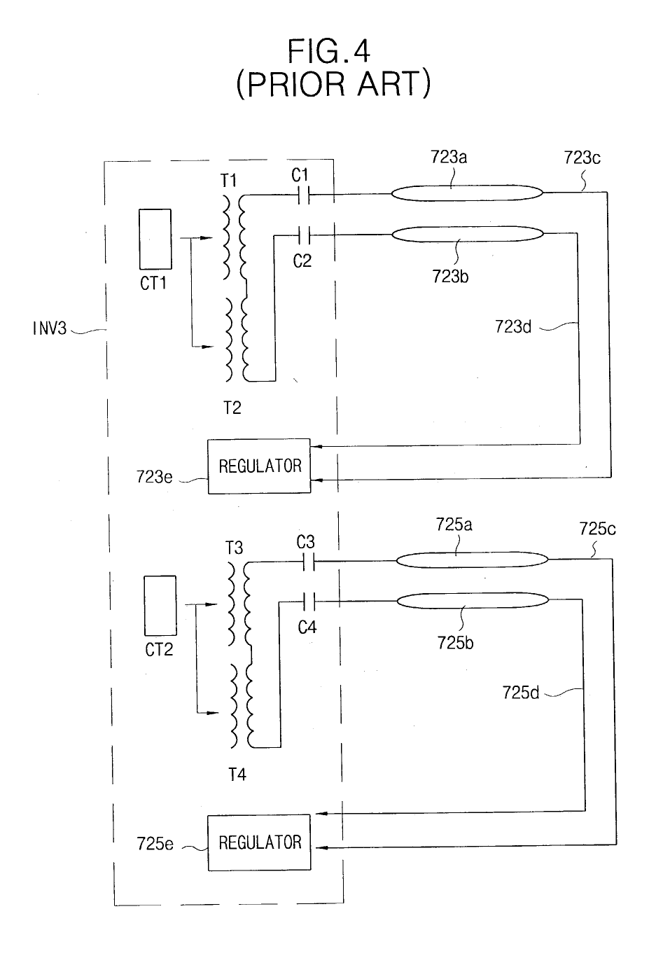

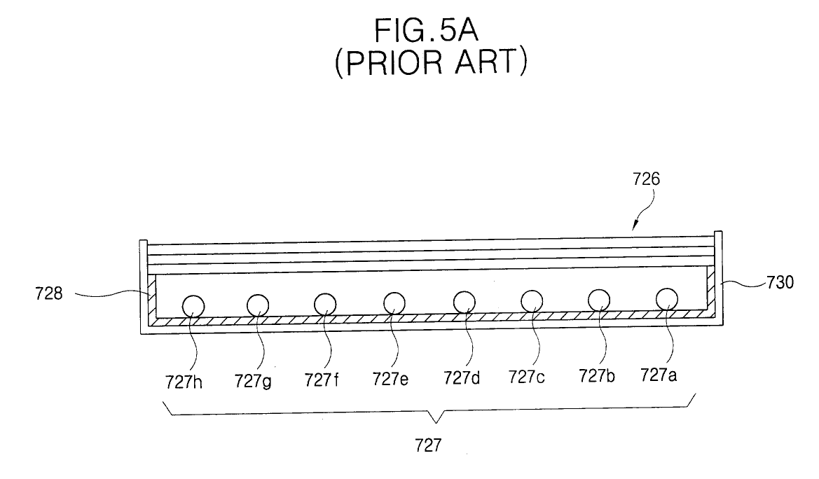

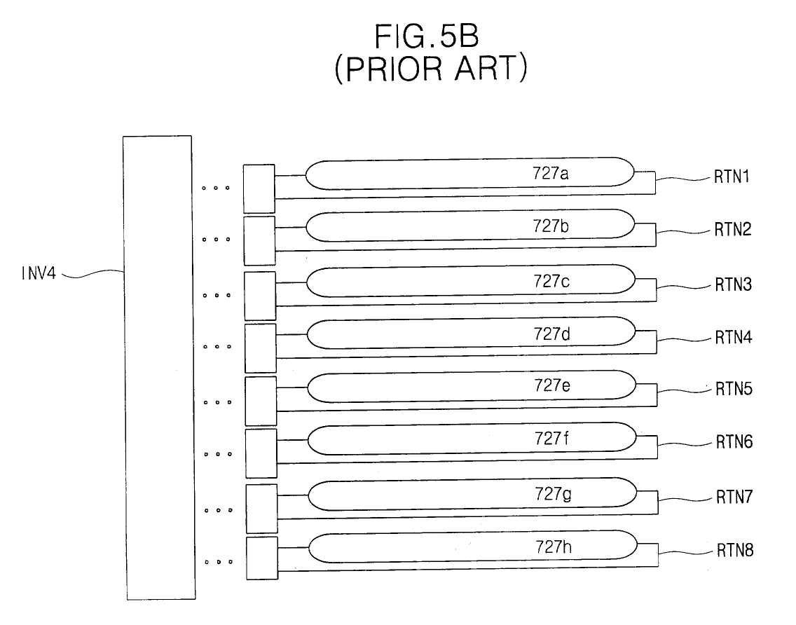

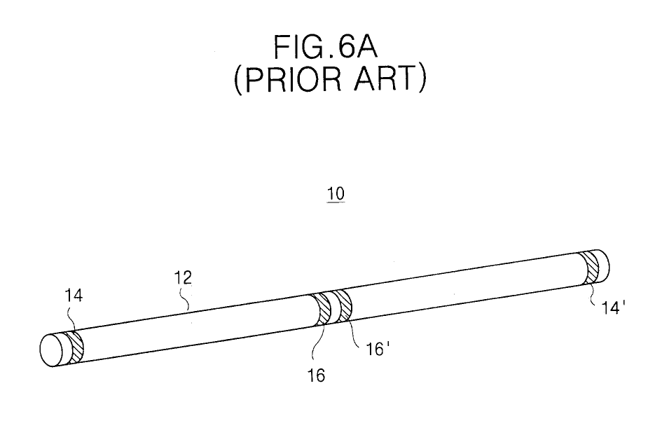

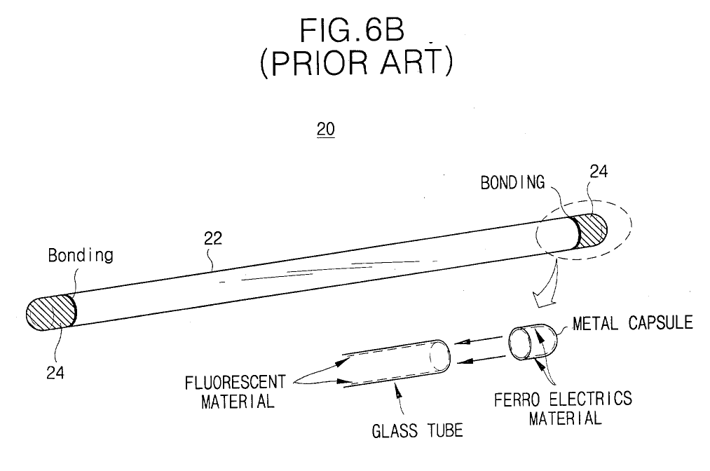

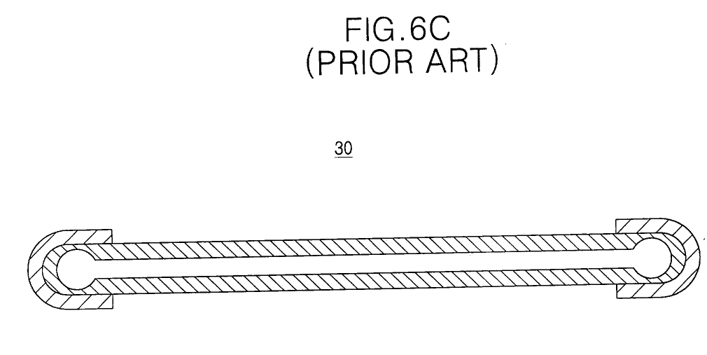

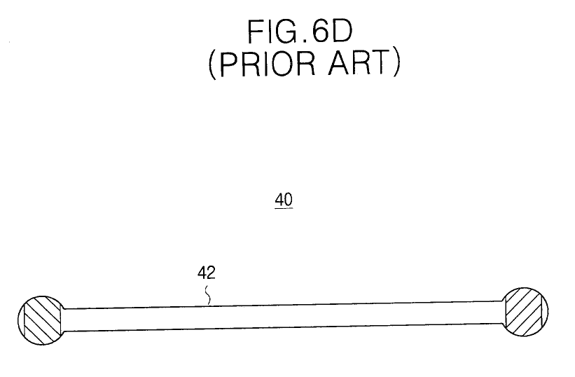

Also, the present invention can be applied to any liquid crystal display device having a backlight assembly with above lamp driving device of the present invention. In other words, the present invention can be applied to a liquid crystal display device having the edge-illuminating type backlight assembly of FIG. 1, and the direct illuminating type backlight assembly of FIG. 5A.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly having an external electrode fluorescent lamp, the backlight assembly comprising:
a lamp driving means for receiving an external DC power signal and an external dimming signal, converting the external DC power signal into an AC power signal, controlling a voltage level of the AC power signal using the external dimming signal, and raising a voltage level of the AC power signal having the controlled voltage level to produce a raised AC power signal;
a light emitting means having a lamp unit, for generating a light based on the raised AC power signal, the lamp unit including a plurality of parallel-connected external electrode fluorescent lamps, and at least one end of each of the external electrode fluorescent lamps having an external electrode; and
an optical distribution changing means for changing an optical distribution of the light generated from the light emitting means.

2. The backlight assembly having an external electrode fluorescent lamp of claim 1, wherein the lamp driving means includes:
a control part for producing a switching signal so as to control a voltage level of the AC power signal based on the external dimming signal;
a switching device for receiving the switching signal and the external DC power signal to produce a pulse power signal; and
a power supplying part for converting the pulse power signal into the AC power signal, and for raising a voltage level of the AC power signal to provide the lamp unit with the raised AC power signal.

3. The backlight assembly having an external electrode fluorescent lamp of claim 1, wherein the power supplying part produces the raised AC power signal having a positive peak value and a negative peak value, the negative peak value being a same magnitude as the positive peak value.

4. The backlight assembly having an external electrode fluorescent lamp of claim 1, wherein the power supplying part provides the lamp unit with the raised AC power signal having a positive peak and a negative peak, an interval between the negative peak and the positive peak being constant or substantially constant.

5. The backlight assembly having an external electrode fluorescent lamp of claim 1, wherein the power supplying part provides a first terminal of the lamp unit with the raised AC power signal, a second terminal of the lamp unit being connected to a ground.

6. The backlight assembly having an external electrode fluorescent lamp of claim 1, the lamp driving means further comprising a diode for preventing a rush current generated by the power supplying part from being applied to the switching device, a first end of the diode being connected to an output terminal of the switching device, and a second end of the diode being connected to a ground.

7. The backlight assembly having an external electrode fluorescent lamp of claim 1, the lamp driving means further comprising a switching device driver for amplifying the switching signal generated from the control part to provide the switching device with the amplified switching signal.

8. The backlight assembly having an external electrode fluorescent lamp of claim 7, the lamp driving means further comprising a digital-to-analogue converter for converting the dimming signal into an analogue dimming signal to provide the control part with the analogue dimming signal so that the control part provides the switching device driver with the switching signal in response to the analogue dimming signal.

9. The backlight assembly having an external electrode fluorescent lamp of claim 1, the power supplying part comprising:
an inductor, connected to an output terminal of the switching device, for receiving the pulse power signal;
a transformer for raising the voltage level of the AC power signal, having a first coil, a second coil and a third coil, the first and second coils being served as a primary coil of the transformer, and the third coil corresponding to the first coil and being served as a secondary coil of the transformer;
a resonant capacitor connected in parallel with both ends of the first coil, the first coil and the resonant capacitor forming an LC resonance circuit;
a first transistor for driving the transformer, a base of the first transistor connected to the inductor through a first resistor, and a collector of the first transistor connected to a first end of the resonant capacitor, and the first coil connected in parallel with the resonant capacitor; and
a second transistor for driving the transformer, a base of the second transistor connected to the inductor through a second resistor, a collector of the second transistor connected to a second end of the resonant capacitor, the first coil connected in parallel with the resonant capacitor, and an emitter of the second transistor commonly coupled with an emitter of the first transistor,
wherein the third coil is connected to both ends of the lamp unit, provides a first end of the lamp unit with a first raised AC power signal, and provides a second end of the lamp unit with a second raised AC power signal, the second AC power signal having a phase difference of about 180° with respect to the first AC power signal.

10. The backlight assembly having an external electrode fluorescent lamp of claim 9, wherein a centered-tap of the first coil receives a DC power signal from the inductor.

11. The backlight assembly having an external electrode fluorescent lamp of claim 1, wherein a first end of the second coil is connected to the base of the first transistor, a second end of the second coil is connected to the base of the second transistor, and the second coil selectively turns on the first and second transistors.

12. The backlight assembly having an external electrode fluorescent lamp of claim 1, the power supplying part comprising:
an inductor connected to an output terminal of the switching device, for receiving the pulse power signal;
a transformer for raising the voltage level of the AC power signal, having a first coil, a second coil and a third coil, the first and second coils being served as a primary coil of the transformer, and the third coil corresponding to the first coil and being served as a secondary coil of the transformer;
a resonant capacitor connected in parallel with both ends of the first coil, the first coil and the resonant capacitor forming an LC resonance circuit;
a first transistor for driving the transformer, a base of the first transistor connected to the inductor through a first resistor, and a collector of the first transistor connected to a first end of the resonant capacitor, and the first coil connected in parallel with the resonant capacitor; and
a second transistor for driving the transformer, a base of the second transistor connected to the inductor through a second resistor, a collector of the second transistor connected to a second end of the resonant capacitor, the first coil connected in parallel with the resonant capacitor, and an emitter of the second transistor commonly coupled with an emitter of the first transistor,
wherein a first end of the third coil is connected to a ground, a second end of the third coil is connected to a second end of the lamp unit, and the third coil provides the lamp unit with the raised AC power signal, the second end of the lamp unit being connected to a ground.

13. The backlight assembly having an external electrode fluorescent lamp of claim 11, wherein a centered-tap of the first coil receives a DC power signal from the inductor.

14. The backlight assembly having an external electrode fluorescent lamp of claim 12, wherein a first end of the second coil is connected to the base of the first transistor, a second end of the second coil is connected to the base of the second transistor, and wherein the second coil selectively turns on the first and second transistors.

15. A backlight assembly having an external electrode fluorescent lamp, the backlight assembly comprising:
a light emitting means having a lamp unit for generating a light, the lamp unit including a plurality of parallel-connected external electrode fluorescent lamps, and an external electrode disposed at least one end of each of the external electrode fluorescent lamps;
a lamp driving means for receiving an external DC power signal and an external dimming signal, converting the external DC power signal into an AC power signal, detecting a level of a current supplied to the lamp unit, controlling a level of a voltage of the AC power signal supplied to the lamp unit based on the external dimming signal and the detected current level, raising a voltage level of the AC power signal having the controlled voltage level to provide the lamp unit with the raised AC power signal so as to control the lamp unit to generate the light using the raised AC power signal; and
an optical distribution changing means for changing an optical distribution of the light generated from the light emitting means.

16. The backlight assembly having an external electrode fluorescent lamp of claim 14, wherein the lamp driving means includes:
a switching device for receiving the switching signal and the external DC power signal to produce a pulse power signal;
a power supplying part for converting the pulse power signal into the AC power signal, for raising a voltage level of the AC power signal, to provide a first end of the lamp unit with a first raised AC power signal and to provide a second end of the lamp unit with a second raised AC power signal, the second raised AC power signal having a phase difference of about 180° with respect to the first raised AC power signal;
a lamp-current detecting part for detecting a level of a current supplied to the lamp unit to produce a current level signal; and
a control part for providing the switching device with the switching signal based on the external dimming signal and the current level signal.

17. The backlight assembly having an external electrode fluorescent lamp of claim 14, the lamp driving means further comprising a switching device driver for amplifying the switching signal generated from the control part to provide the switching device with the amplified switching signal.

18. The backlight assembly having an external electrode fluorescent lamp of claim 15, the lamp driving means further comprising a diode for preventing a rush current generated by the power supplying part from being applied to the switching device, a first end of the diode being connected to an output terminal of the switching device, and a second end of the diode being connected to a ground.

19. The backlight assembly having an external electrode fluorescent lamp of claim 15, wherein the lamp-current detecting part detects a current level of the AC power signal before raising the voltage level of the AC power signal to provide the control part with the current level signal.

20. The backlight assembly having an external electrode fluorescent lamp of claim 15, the power supplying part comprising:
an inductor connected to an output terminal of the switching device, for receiving the pulse power signal;
a transformer for raising the voltage level of the AC power signal, having a first coil, a second coil and a third coil, the first and second coils being served as a primary coil of the transformer, and the third coil corresponding to the first coil and being served as a secondary coil of the transformer;
a resonant capacitor connected in parallel with both ends of the first coil, the first coil and the resonant capacitor forming an LC resonance circuit;
a first transistor for driving the transformer, a base of the first transistor connected to the inductor through a first resistor, and a collector of the first transistor connected to a first end of the resonant capacitor, and the first coil connected in parallel with the resonant capacitor; and
a second transistor for driving the transformer, a base of the second transistor connected to the inductor through a second resistor, a collector of the second transistor connected to a second end of the resonant capacitor, the first coil connected in parallel with the resonant capacitor.

21. The backlight assembly having an external electrode fluorescent lamp of claim 20, wherein the lamp-current detecting part is coupled with both the first transistor and the second transistor, and detects the level of the current supplied to the lamp unit to produce a current level signal, the first transistor connected with a first end of the first transformer, and the second transistor connected with a second end of the first transformer.

22. The backlight assembly having an external electrode fluorescent lamp of claim 21, the lamp-current detecting part comprising:
a capacitor, a first end of the capacitor being connected to a ground, and a second end of the capacitor being connected to a terminal through which the first and second transistors are commonly coupled;
a first resistor, a first end of the first resistor being connected to a ground, and a second end of the first resistor being connected to the second end of the capacitor;
a diode, a first end of the diode being connected to a ground, and a second end of the diode being connected to the second end of the resistor; and
a second resistor for producing the current level signal, a first end of the second resistor being connected to the second end of the diode, and a second end of the second resistor being connected to the control part.

23. The backlight assembly having an external electrode fluorescent lamp of claim 15, wherein the lamp-current detecting part detects a current level of the AC power signal after raising the voltage level of the AC power signal to provide the control part with the current level signal.

24. The backlight assembly having an external electrode fluorescent lamp of claim 23, the power supplying part comprising:
an inductor, connected to an output terminal of the switching device, for receiving the pulse power signal;
a transformer for raising the voltage level of the AC power signal, having a first coil, a second coil, a third coil and a fourth coil, the first and second coils being served as a primary coil of the transformer, and the third and the fourth coils corresponding to the first coil and being served as a secondary coil of the transformer;
a resonant capacitor connected in parallel with both ends of the first coil, the first coil and the resonant capacitor forming an LC resonance circuit;
a first transistor for driving the transformer, a base of the first transistor connected to the inductor through a first resistor, and a collector of the first transistor connected to a first end of the resonant capacitor, and the first coil connected in parallel with the resonant capacitor; and
a second transistor for driving the transformer, a base of the second transistor connected to the inductor through a second resistor, a collector of the second transistor connected to a second end of the resonant capacitor, the first coil connected in parallel with the resonant capacitor.

25. The backlight assembly having an external electrode fluorescent lamp of claim 24, the lamp-current detecting part comprising:
a first capacitor, a first end of the first capacitor being connected to a ground, and a second end of the first capacitor being connected to a first end of the third coil;
a first resistor, a first end of the first resistor being connected to a ground, and a second end of the first resistor being connected to the second end of the first capacitor;
a first diode, a first end of the first diode being connected to a ground, and a second end of the first diode being connected to the second end of the first resistor; and
a second resistor for producing a first current level signal, a first end of the second resistor being connected to the second end of the first diode, and a second end of the second resistor being connected to the control part;
a second capacitor, a first end of the second capacitor being connected to a ground, and a second end of the second capacitor being connected to a first end of the fourth coil;
a third resistor, a first end of the third resistor being connected to a ground, and a second end of the third resistor being connected to the second end of the second capacitor;
a second diode, a first end of the second diode being connected to a ground, and a second end of the second diode being connected to the second end of the third resistor; and
a fourth resistor for producing a second current level signal, a first end of the fourth resistor being connected to the second end of the second diode, and a second end of the fourth resistor being connected to the control part.

26. A backlight assembly having an external electrode fluorescent lamp, the backlight assembly comprising:
a light emitting means having a lamp unit for generating a light, the lamp unit including a plurality of parallel-connected external electrode fluorescent lamps, an external electrode being disposed at least one end of each of the external electrode fluorescent lamps, and a first end of the lamp unit being connected to a ground;
a lamp driving means for receiving an external DC power signal, converting the external DC power signal into an AC power signal, detecting a level of a current supplied to the lamp unit, controlling a level of a voltage of the AC power signal supplied to the lamp unit based on the detected current level, raising a voltage level of the AC power signal having the controlled voltage level to provide the lamp unit with the raised AC power signal so as to control the lamp unit to generate the light using the raised AC power signal; and
an optical distribution changing means for changing an optical distribution of the light generated from the light emitting means.

27. The backlight assembly having an external electrode fluorescent lamp of claim 26, wherein the lamp driving means includes:
a switching device for receiving the switching signal and the external DC power signal to produce a pulse power signal;
a power supplying part for converting the pulse power signal into the AC power signal, and for raising the voltage level of the AC power signal to provide the lamp unit with the raised AC power signal;
a lamp-current detecting part for detecting the level of the current supplied to the lamp unit to produce a current level signal; and
a control part for providing the switching device with the switching signal so as to control the voltage level of the AC power signal based on the current level signal.

28. The backlight assembly having an external electrode fluorescent lamp of claim 26, the lamp driving means further comprising a switching device driver for amplifying the switching signal generated from the control part to provide the switching device with the amplified switching signal.

29. The backlight assembly having an external electrode fluorescent lamp of claim 26, wherein the lamp-current detecting part detects a current level of the AC power signal before raising the voltage level of the AC power signal to provide the control part with the current level signal.

30. The backlight assembly having an external electrode fluorescent lamp of claim 29, the power supplying part comprising:
an inductor, connected to an output terminal of the switching device, for receiving the pulse power signal;
a transformer for raising the voltage level of the AC power signal, having a first coil, a second coil and a third coil, the first and second coils being served as a primary coil of the transformer, and the third coil corresponding to the first coil and being served as a secondary coil of the transformer;
a resonant capacitor connected in parallel with both ends of the first coil, the first coil and the resonant capacitor forming an LC resonance circuit;
a first transistor for driving the transformer, a base of the first transistor connected to the inductor through a first resistor, and a collector of the first transistor connected to a first end of the resonant capacitor, and the first coil connected in parallel with the resonant capacitor; and
a second transistor for driving the transformer, a base of the second transistor connected to the inductor through a second resistor, a collector of the second transistor connected to a second end of the resonant capacitor, and an emitter of the second transistor and an emitter of the first transistor commonly connected to a ground,
wherein a first end of the third coil is connected to a ground, a second end of the third coil is connected to a second end of the lamp unit, and the third coil provides the lamp unit with the raised AC power signal, the second end of the lamp unit being connected to a ground.

31. The backlight assembly having an external electrode fluorescent lamp of claim 30, wherein the lamp-current detecting part is coupled with both the first transistor and the second transistor, and detects the level of the current supplied to the lamp unit to produce a current level signal, the first transistor connected with a first end of the first transformer, and the second transistor connected with a second end of the first transformer.

32. A method of driving an external electrode fluorescent lamp in a lamp unit, the lamp unit including a plurality of parallel-connected external electrode fluorescent lamps, and an external electrode disposed at least one end of each of the external electrode fluorescent lamps, the method comprising:
(a) converting an external dimming signal into an analogue dimming signal;
(b) generating a switching signal based on an external on-off control signal and the analogue dimming signal;
(c) converting an external DC power signal into a pulse power signal based on the switching signal;
(d) converting the pulse power signal into an AC power signal;
(e) raising a voltage level of the AC power signal to produce a raised AC power signal; and
(f) providing the lamp unit with the raised AC power signal.

33. The method of driving an external electrode fluorescent lamp of claim 31, wherein the raised AC power signal is a AC signal having a positive peak value and a negative peak value, a difference between the negative peak value and the positive peak value being constant or substantially constant.

34. The method of driving an external electrode fluorescent lamp of claim 32, wherein a first raised AC power signal of the raised AC power signal is supplied to a first end of the lamp unit, and a second raised AC power signal of the raised AC power signal is supplied to a second end of the lamp unit, the second AC power signal having a phase difference of about 180° with respect to the first AC power signal.

35. The method of driving an external electrode fluorescent lamp of claim 32, wherein the raised AC power signal is supplied to a second end of the lamp unit, a first end of the lamp unit being connected to a ground.

36. A method of driving an external electrode fluorescent lamp in a lamp unit, the lamp unit including a plurality of parallel-connected external electrode fluorescent lamps, and an external electrode disposed at least one end of each of the external electrode fluorescent lamps, the method comprising:
(a) converting an external dimming signal into an analogue dimming signal;
(b) generating a first switching signal based on an external on-off control signal and the analogue dimming signal;
(c) converting an external DC power signal into a pulse power signal based on the first switching signal;
(d) converting the pulse power signal into an AC power signal;
(e) raising a voltage level of the AC power signal to produce a raised AC power signal;
(f) providing a first end of the lamp unit with a first raised AC power signal of the raised AC power signal;
(g) providing a second end of the lamp unit with a second raised AC power signal of the raised AC power signal, the second raised AC power signal having a phase difference of about 180° with respect to the first raised AC power signal;
(h) detecting a current level of a current supplied to the lamp unit to produce a current level signal; and
(i) generating a second switching signal based on the current level signal, the on-off control signal and the first switching signal, and then returning back to the step (c).

37. The method of driving an external electrode fluorescent lamp of claim 36, wherein a first raised AC power signal of the raised AC power signal is supplied to a first end of the lamp unit, and a second raised AC power signal of the raised AC power signal is supplied to a second end of the lamp unit, the second AC power signal having a phase difference of about 180° with respect to the first AC power signal.

38. A method of driving an external electrode fluorescent lamp in a lamp unit, the lamp unit including a plurality of parallel-connected external electrode fluorescent lamps, an external electrode disposed at least one end of each of the external electrode fluorescent lamps, and a first end of the lamp unit being connected to a ground, the method comprising:
(a) converting an external dimming signal into an analogue dimming signal;
(b) generating a first switching signal based on an external on-off control signal and the analogue dimming signal;
(c) converting an external DC power signal into a pulse power signal based on the first switching signal;
(d) converting the pulse power signal into an AC power signal;
(e) raising a voltage level of the AC power signal to produce a raised AC power signal;
(f) providing a second end of the lamp unit with the raised AC power signal;
(g) detecting a current level of a current supplied to the lamp unit to produce a current level signal; and
(h) generating a second switching signal based on the current level signal, the on-off control signal and the first switching signal, and then returning back to the step (c).

39. A liquid crystal display apparatus comprising:
a backlight assembly including i) a lamp driving means for receiving an external DC power signal and an external dimming signal, converting the external DC power signal into an AC power signal, controlling a voltage level of the AC power signal using the external dimming signal, and raising a voltage level of the AC power signal having the controlled voltage level to produce a raised AC power signal, ii) a light emitting means having a lamp unit, for generating a light based on the raised AC power signal, the lamp unit including a plurality of parallel-connected external electrode fluorescent lamps, and at least one end of each of the external electrode fluorescent lamps having an external electrode, and iii) an optical distribution changing means for changing an optical distribution of the light generated from the light emitting means; and
a display unit, disposed on the optical distribution changing means, for displaying an image by receiving the light from the light emitting means.

40. The liquid crystal display apparatus of claim 39, wherein the lamp driving means includes:
a control part for producing a switching signal so as to control a voltage level of the AC power signal based on the external dimming signal;
a switching device for receiving the switching signal and the external DC power signal to produce a pulse power signal; and
a power supplying part for converting the pulse power signal into the AC power signal, and for raising a voltage level of the AC power signal to provide the lamp unit with the raised AC power signal.

41. A liquid crystal display apparatus comprising:
a backlight assembly including i) a light emitting means having a lamp unit for generating a light, the lamp unit including a plurality of parallel-connected external electrode fluorescent lamps, and an external electrode disposed at least one end of each of the external electrode fluorescent lamps ii) a lamp driving means for receiving an external DC power signal and an external dimming signal, converting the external DC power signal into an AC power signal, detecting a level of a current supplied to the lamp unit, controlling a level of a voltage of the AC power signal supplied to the lamp unit based on the external dimming signal and the detected current level, raising a voltage level of the AC power signal having the controlled voltage level to provide the lamp unit with the raised AC power signal so as to control the lamp unit to generate the light using the raised AC power signal, and iii) an optical distribution changing means for changing an optical distribution of the light generated from the light emitting means; and
a display unit, disposed on the optical distribution changing means, for displaying an image by receiving the light from the light emitting means.

42. The liquid crystal display apparatus of claim 39, wherein the lamp driving means includes:
a switching device for receiving the switching signal and the external DC power signal to produce a pulse power signal;
a power supplying part for converting the pulse power signal into the AC power signal, for raising a voltage level of the AC power signal to provide a first end of the lamp unit with a first raised AC power signal and to provide a second end of the lamp unit with a second raised AC power signal, the second raised AC power signal having a phase difference of about 180° with respect to the first raised AC power signal;
a lamp-current detecting part for detecting a level of a current supplied to the lamp unit to produce a current level signal; and
a control part for providing the switching device with the switching signal based on the external dimming signal and the current level signal.

43. A liquid crystal display apparatus comprising:
a backlight assembly including i) a light emitting means having a lamp unit for generating a light, the lamp unit including a plurality of parallel-connected external electrode fluorescent lamps, an external electrode being disposed at least one end of each of the external electrode fluorescent lamps, and a first end of the lamp unit being connected to a ground, ii) a lamp driving means for receiving an external DC power signal, converting the external DC power signal into an AC power signal, detecting a level of a current supplied to the lamp unit, controlling a level of a voltage of the AC power signal supplied to the lamp unit based on the detected current level, raising a voltage level of the AC power signal having the controlled voltage level to provide the lamp unit with the raised AC power signal so as to control the lamp unit to generate the light using the raised AC power signal, and iii) an optical distribution changing means for changing an optical distribution of the light generated from the light emitting means; and
a display unit, disposed on the optical distribution changing means, for displaying an image by receiving the light from the light emitting means.

44. The liquid crystal display apparatus of claim 43, wherein the lamp driving means includes:
a switching device for receiving the switching signal and the external DC power signal to produce a pulse power signal;
a power supplying part for converting the pulse power signal into the AC power signal, and for raising a voltage level of the AC power signal to provide the lamp unit with a raised AC power signal;
a lamp-current detecting part for detecting a level of a current supplied to the lamp unit to produce a current level signal; and
a control part for producing the switching signal so as to control a voltage level of the AC power signal based on the current level signal.
